(19) United States
(12) Patent Application Publication
(10) Pub. No.: US 2004/0161712 A1
(43) Pub. Date: Aug. 19, 2004

(54) Deformable colour photographic silver halide material

(75) Inventors: Ly Cuong, Koln (DE); Markus Geiger, Leverkusen (DE); Leon Vermeulen, Herenthout (BE); Arno Schmuck, Leichlingen (DE)

Correspondence Address: CONNOLLY BOVE LODGE & HUTZ, LLP, P O BOX 2207, WILMINGTON, DE, 19899, US

(73) Assignee: Agfa-Gevaert

(21) Appl. No.: 10/714,022

(22) Filed: Nov. 14, 2003

Related U.S. Application Data
(60) Provisional application No. 60/429,457, filed on Nov. 27, 2002.

(30) Foreign Application Priority Data
Nov. 15, 2002 (EP) EP 02 102 598.6

(51) Int. Cl. G03C 1/035; G03C 1/765; G03C 1/795; G03C 7/30; G03C 11/06; G03C 11/00

(52) U.S. Cl. 430/350; 430/383; 430/496; 430/403; 430/432; 430/503; 430/533; 430/536; 430/567

(57) ABSTRACT

A deformable color photographic silver halide material, said color photographic silver halide material comprising on a deformable plastic support at least one blue-sensitive silver halide emulsion layer containing at least one yellow coupler, at least one green-sensitive silver halide emulsion layer containing at least one magenta coupler and at least one red-sensitive silver halide emulsion layer containing at least one cyan coupler, wherein the silver halide emulsions have an overall silver chloride content of at least 95 mol % and at least one silver halide emulsion contains silver halide crystals that are doped with 10 to 700 nmol iridium

### CROSS-REFERENCE TO RELATED PATENT APPLICATIONS

This application claims the benefit of U.S. Provisional Application No. 60/429,457 filed Nov. 27, 2002, which is incorporated by reference. In addition, this application claims the benefit of European Application No. 02102598.6 filed Nov. 15, 2002, which is also incorporated by reference.

### FIELD OF THE INVENTION

The present invention relates to a deformable material for producing a deformed image without significant image degradation, said material has a good storage stability and is suitable for digital exposure with very short pixeltimes, large formats and automatic processing.

### BACKGROUND OF THE INVENTION

Deformable materials with color and/or black and white motives, particularly those made of plastic, are used e.g. as protective and/or decorative foils particularly in the furniture industry, in which they are used as design elements to cover low-priced and/or light weight carrier materials and/or carrier materials that are critical to the conditions of their use; the configuration of deformable material and carrier material replacing much more expensive and/or heavier and/or less easier to handle and/or less resistant materials such as real wood, stainless steel or marble.

The manufacture of deformed plastic pieces with any kind of representations like images, designs, patterns, letters and so forth, usually proceeds by printing on an undeformed flat foil of a thermoplastic polymer and is then deformed using heat and pressure.

The results obtained are unsatisfactory, because the printed pieces after deformation exhibit a loss in image quality, that is visible at all parts where the deformation has led to an elongation of the deformed material. In particular a significant loss in image quality is observed after deformation at curved parts and still more so at sharp edges, which is particularly noticeable as a bright line and/or increase granularity following the curves and/or edges in homogeneously coloured dark areas, which is unacceptable, particularly in the case of decorated furniture. Furthermore, the printing processes require complicated prepress steps and are therefore expensive and are not suitable for the manufacture of individual designs with small production runs.

Photographic layers, which were laminated onto a support, have, for example, been disclosed in EP-A 0 250 657, U.S. Pat. No. 3,871,119, EP-A 0 490 416 and EP-A 0 276 506 for the manufacture of materials for identity cards and in EP-A 1 189 108 have been disclosed for materials with a broader color gamut. The layers can subsequently be covered with a protective foil, as disclosed, for example, in U.S. Pat. No. 4,370,397 and GB 2,121,812.

The disclosed ID-cards are all flat, so that there are no requirements regarding deformability and their suitability or otherwise therefor was not disclosed.

Furthermore, as laminatable photographic layers those with special binders have been disclosed, although neither of these options produces an optimum image quality. In particular the graininess realized with state of the art laminatable materials is unacceptably high. The DTR materials that are also known to be laminatable, are not suitable for the furniture industry, because the two-sheet process has not been adapted to the large format automated processing needed in this field.

Representations like images, designs, patterns, letters and so forth, of the highest quality can be realized with color photographic materials, comprising on a support at least one blue-sensitive silver halide emulsion layer containing at least one yellow coupler, at least one green-sensitive silver halide emulsion layer containing at least one magenta coupler and at least one red-sensitive silver halide emulsion layer containing at least one cyan coupler. As a support for reflective material, paper coated on both sides with polyethylene and for transparent materials longitudinally and laterally stretched polyester is usually used. The deformation according to the present invention of such color photographic materials is not possible.

The deformability of special photographic materials consisting of a support, an optional adhesive layer and a black and white silver halide emulsion photographic layer with special binders was disclosed in FR 968 638 and GB 739,477. According to FR 968 638 gelatin cannot be used as a binder, because cracking occurred upon bending.

The known deformable photographic materials as disclosed in FR 968 638 and GB 739 477 did not fulfill the present quality requirements for photographically produced images and the bending behaviour was unsatisfactory.

GB 2,321,977 and the corresponding W098/35269 disclose a mouldable photographic material comprising a thermoplastic base sheet, a primer layer providing a key for a light sensitive layer, and a protective thermoplastic foil, the foil being bonded to the light sensitive layer with an optical quality adhesive.

Furthermore, no deformable photographic materials are known, which are satisfactory for both a long exposure and for a digital exposure with very short pixeltimes, such as, for example, required in the furniture industry, to enable the exposure of large formats. Analogue long exposures are desirable so that inexpensive exposure configurations can be used, but digital exposure is being increasingly required, because it is much faster and because rolls of film are much easier to expose continuously. Furthermore, different designs can be much more easily realized in production, since no film is necessary as an intermediate step. Nowadays new designs are usually produced by computer and can be directly used in digital exposure to realize optimal image quality.

Digital exposure, also known as scanning exposure, proceeds pixel-wise, line-wise or area-wise with high intensity strongly focussed beam of light beam e.g. from lasers, light emitting diodes (LED), DMD (digital micromirror devices) apparatuses, cathode ray tubes and such like and with short to very short exposure times per pixel. A pixel is the smallest image area on the copying material, which can be addressed by the exposure apparatus. Conventional silver halide emulsions exhibit a too low sensitivity, due to an unsatisfactory reciprocity, which results in a too low contrast and insufficient maximum density at such short exposure times.

A similar reciprocity failure is also observed at exposure times above 10 s (long exposure times), which are necessary for analogue exposure of large formats.

Furthermore, the known deformable photographic materials are unsatisfactory with regard to the storage stability of the unexposed and unprocessed materials, in particular when the support of the photographic material contains additives like plastizisers, stabilizers, and so forth.

### OBJECTS OF THE INVENTION

It is therefore an object of the present invention to provide a deformable color photographic material, which enables high quality representations like images, designs, patterns, letters and so forth to be realized, which undergo the desired deformation by heat and/or pressure without significant visible loss in image quality. A further advantage of the present invention compared to printing processes is the possibility to produce even single pieces as a proof or demonstration example.

Further aspects and advantages of the invention will become apparent from the description hereinafter.

### SUMMARY OF THE INVENTION

It has been surprisingly found, that the deformable color photographic recording material of the present invention is suitable for digital exposure even at pixel times lower then 200 ns, exhibits a very good storage stability of the unexposed and unprocessed material and gives high quality images, said color photographic silver halide material comprising on a deformable plastic support at least one blue-sensitive silver halide emulsion layer containing at least one yellow coupler, at least one green-sensitive silver halide emulsion layer containing at least one magenta coupler and at least one red-sensitive silver halide emulsion layer containing at least one cyan coupler, wherein the silver halide emulsions have an overall silver chloride content of at least 95 mol % and at least one silver halide emulsion contains silver halide crystals that are doped with 10 to 700 nmol, preferably 10 to 500 nmol Ir.

Surprisingly it has been found, at variance with the disclosure in FR 968 638, that gelatin can be successfully used in the materials used in the process according to the present invention. The reason why the use of gelatin failed according to FR 968 638, but surprisingly was very successful for the present invention, may be the difference between single layer black and white materials like those described in FR 968 638, that essentially only contain silver halide crystals dispersed in the binder, and multilayer color photographic materials according to the present invention, that also comprise softer materials like couplers in their layers.

Aspects of the present invention are realized with a deformable color photographic silver halide material, the color photographic silver halide material comprising on a deformable plastic support at least one blue-sensitive silver halide emulsion layer containing at least one yellow coupler, at least one green-sensitive silver halide emulsion layer containing at least one magenta coupler and at least one red-sensitive silver halide emulsion layer containing at least one cyan coupler, wherein the silver halide emulsions have an overall silver chloride content of at least 95 mol % and at least one silver halide emulsion contains silver halide crystals that are doped with 10 to 700 nmol iridium.

Aspects of the present invention are also realized with a process for producing a deformed image comprising the steps of: exposing the above-mentioned color photographic silver halide material, preferably digitally; conventionally processing the exposed color photographic material to produce an image; and deforming the color photographic material.

### DETAILED DESCRIPTION OF THE INVENTION

### Definitions

The term deformation (also known as moulding) used in disclosing the present invention refers to three-dimensional deformation in which an initially flat object e.g. a plate or a sheet is deformed to a three dimensional shape using a shaping tool to which pressure and/or heat is applied, in the course of which at least a part of the initially flat object is elongated (stretched), the shape being maintained upon cooling and/or upon releasing the pressure. The out-of-plane deformation is usually of a greater measure than the thickness of the initially flat object, the thickness being defined as the distance between the surface to which the tool is applied and the opposite surface of the initially flat object. The term deformable as used in qualifying color photographic silver halide material is the ability to undergo deformation as defined above.

The term to deform means the process of deformation.

The term deformable plastic as used in disclosing the present invention includes all polymers, which can be deformed, without fracturing, exhibiting cracks or thermally decomposing. The term deformable plastic includes all polymers, that are available in foil form and that are not stretched.

The term conventional processing as used in disclosing the present invention means chromogenic chemical color processing as used for the processing of conventional photographic materials such as color papers, color films or display materials and is further specified in the following description.

The terms immediate and fast hardeners mean that the hardener is capable of hardening gelatin immediately after coating or at least several days after coating to such an extent that no further changes in sensitometry and swelling behaviour due to the presence of hardener occur. By swelling is meant the difference between wet layer thickness and dry layer thickness upon aqueous processing of the material.

The term silver nitrate (equivalent to AgX present) is used in the examples to characterize the silver halide emulsions means the weight of silver nitrate in a given amount of silver halide emulsion that results when the quantity of silver halide in the emulsion is hypothetically converted into the equivalent weight of silver nitrate.

### Process for Producing a Deformed Image

Aspects of the present invention are also realized with a process for producing a deformed image comprising the steps of: exposing the above-mentioned color photographic silver halide material, according to the present invention, preferably digitally; conventionally processing the exposed color photographic material to produce an image; and deforming the color photographic material.

There are commonly used apparatus available for exposure and conventional processing of the photographic material of the present inventions that are able to process long and wide sheets as well as wide rolls of the material as are needed e.g. in the furniture industry.

Exposure preferably is carried out digitally and proceeds preferably from the side remote from the support, but in the case of a transparent or slightly coloured support exposure can also be carried out through the support if a loss in sharpness is tolerable.

To avoid light scattering and resulting loss in sharpness in the case of a transparent or translucent support, it is preferred to place a dark sheet in contact with the side of the material remote from the light source upon exposure. The same effect can be achieved when the material comprises an antihalation layer, that is bleached during the chemical processing of the material. Suitable absorbing material for said antihalation layer is described in Research Disclosure 38 957, 1996, VIII., from page 610, herein incorporated by reference. The antihalation layer has to be arranged on the side of the emulsion layers remote from the light source.

In a preferred embodiment of the deformable color photographic silver halide material, according to the present invention, the support is provided on the image side between the silver halide layers and the support with a layer reflecting white light and on the opposite side with a non-bleachable black antihalation layer as described in U.S. Pat. No. 4 224 402, herein incorporated by reference.

After image-wise exposure the color photographic material is appropriately processed. Details of processing and the chemicals required therefor together with exemplary color photographic materials are to be found in Research Disclosure 37254, part 10 (1995) page 294 and in Research Disclosure 37038, parts XVI to XXIII (1995), from page 95, herein incorporated by reference. Conventional processing of the color photographic material comprises the steps of chromogenic development, bleaching and fixing and for color reversal materials in addition a reversal step and a black and white development. The bleaching and fixing steps can be carried out within one bleach/fixing step. Processes and the compounds especially suitable for the process of the present invention are commonly known in the art and described e.g. in Ullmann's Encyclopedia of Industrial Chemistry, 5^{th} edition, Vol. A20, p 68 to 98, herein incorporated by reference, in particular the color negative paper processes such as EP-2 (Eastman Kodak) and AP 92 (Agfa) for silver bromide chloride emulsions and RA-4 (Eastman Kodak) and AP 94 (Agfa) processes for predominantly silver chloride emulsions.

In another preferred embodiment of the process, according to the present invention, the conventional processing of the color photographic material is carried out with development times between 15 and 130 s. Longer development times are necessary, if, for example, silver-rich materials are processed in order to attain a particularly high color density.

### Deformable Plastic Support

Deformable plastics are those which can be deformed, without fracturing, exhibiting cracks or thermally decomposing. All polymers, that are available in foil form and that are not stretched fall under the term deformable plastics.

A good reference point for the temperature necessary for deformation is the glass transition temperature (Tg). Deformation is usually done between the glass transition temperature and the melting point of the deformable plastic. The pressure needed for deformation can easily be tested; the higher the deformation temperature is with respect to the glass transition temperature, the lower the pressure needed. Just below the melting point only a very low pressure is needed. The time needed for the deformation can also be easily tested and adjusted. A higher temperature and/or a higher pressure results in a shorter time.

Suitable support materials, e.g. foils, films or sheets, are preferably taken from the group of plastics knows as thermoplastics and include poly(vinylchloride) (PVC), polycarbonate (PC), non-oriented polyester, acrylonitrile-butadiene-styrene (ABS), polyolefin, copolymers and mixtures of said polymers. Suitable copolymers include vinylchloride copolymer, in particular ABS copolymerized with vinylchloride and polyolefin copolymer.

According to a preferred embodiment of the deformable color photographic silver halide material, according to the present invention, deformable plastic support is a polycarbonate, poly(vinylchloride), vinylchloride copolymer or a polyester; or a copolyester based on PET.

Suitable polycarbonates for use in the color photographic material of the present invention, contain repeating units represented by the formula

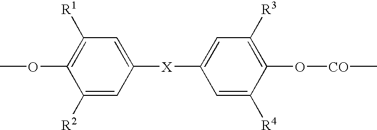

wherein X represents —S—, —SO₂—, —C(R₅, R₆)— or —C[═C(R₇,R₈)]—; R₁, R₂, R₃, R₄, R₇ and R₈ independently represent a hydrogen atom, or an alkyl- or aryl- group; and R₅ and R₆ independently represent a hydrogen atom or an alkyl- or aryl- group or together represent the atoms necessary to form a cycloaliphatic ring, e.g. a cyclohexane ring. The polycarbonates preferably have weight averaged molecular weights between 10,000 and 500,000. Polycarbonates based on bisphenol A are particularly preferred. Poly(vinylchloride) for use in the color photographic material of the present invention, preferably contain at least 50% by weight vinylchloride units and optionally contain further hydrophobic units. Preferred comonomers are vinylidene chloride, vinyl acetate, acrylonitrile, styrene, butadiene, chloroprene, dichlorobutadiene, vinyl fluoride, vinylidene fluoride and trifluroethylene.

The poly(vinylchloride) preferably contains 60 to 65% by weight of chlorine. A PVC support used in the color photographic material of the present invention, can contain plasticizers, but for ecological reasons and for reasons of stability of the photographic material preferably contains no plasticizers. Furthermore, the PVC can contain stabilizers and antioxidants with inorganic heavy metal salts, metal soaps (particularly of Ba, Cd, Pb, Zn and Ca), dibutyl and dioctyl tin compounds and epoxidized soya oil. Further optional ingredients of PVC include lubricants, impact modifier, process aids, fillers, fire retardants, smoke repressants, blowing agents, colourants, antistatic agents, viscosity modifier, biostabilizers and UV absorber.

Suitable polyesters include condensation products of aromatic, aliphatic or cycloaliphatic dicarboxylic acids with aliphatic or alicyclic glycols, whereby the dicarboxylic acids have preferably 4 to 20 C-atoms and the glycols preferably 2 to 24 C-atoms. The polyesters can also be modified by adding small quantities of other monomers. Preferred polyesters are poly(ethylene terephthalate) (PET) or copolyesters based on PET (COPET) such as the preferred COPET Eastar PETG Copolyester 6763 delivered by Eastman (PETG). However, stretched (oriented) polyesters are unsuitable, because they form micro-cracks upon deformation.

Suitable polyolefins include polypropylene, polyethylene and polymethylpentene either individually or as mixtures. Preferred polyolefins include copolymers of propylene and/or ethylene with hexene and/or butene and/or octene.

Preferred deformable plastics for deformable color photographic materials, according to the present invention, are PVC, vinylchloride copolymer and PC, because they bend well and the photographic layer is particularly little affected. PC is particularly preferred due to its high tensile strength and ensures a good storage stability.

The support can be a single layer foil, but can also consist of a compound arrangement of several plastic foils. All plastic foils must be of a deformable plastic. The thickness of the support is preferably between 0.05 and 0.75 mm.

The support can be coated with one or several layers to provide the support with e.g. a color layer or an adhesive layer.

Depending upon the desired effect, the support can be white, transparent, translucent or coloured with dyes or pigments and may also have structure or roughness on either or both sides. Structure or roughness in the foil is preferably realized during its manufacture.

The support may contain pigments or other colorants. An opaque, white color can be realized by coextrusion of white pigments such as titanium dioxide. Suitable colorants include dyes such as Ultramarine Blue.

To improve the adhesion of hydrophilic layers of color photographic materials on hydrophobic supports, it is preferred to pretreat the support with a hydrophilizing process, for example corona (air ionization at about 10 to 20 kV) treatment. Furthermore, a subbing layer between the support and the layer of the layer configuration of the color photographic material closest to the support is also preferred.

In a preferred embodiment of the deformable color photographic silver halide material, according to the present invention, the deformable color photographic material further contains a subbing layer containing 1.3 to 80% by weight of a proteinaceous colloid, 0 to 85% by weight of colloidal silica and 0 to 30% by weight of a siloxane, which can form a reaction product with the colloidal silica. In a further preferred embodiment of the deformable color photographic silver halide material, according to the present invention, the deformable color photographic material, further contains a subbing layer on the same side of the support as the silver halide emulsion layers. Particularly preferred is a subbing layer that further contains 1.0 to 70% by weight of an ionogenic polyester-polyurethane, which is coated from an aqueous dispersion, in which isocyanate groups in its structure have reacted with an ionomer compound, which contains at least one active hydrogen atom and a carboxylate or sulphonate salt group, and in which the number of salt groups is sufficiently high to render the polyester-polyurethane dispersible in an aqueous medium. Preferred proteinaceous colloids are gelatin and casein, with gelatin being particularly preferred. Suitable anionic polyester-polyurethanes are disclosed in U.S. Pat. No. 3,397,989, U.S. Pat. No. 4,388,403 and DE-OS 3 630 045, herein incorporated by reference, with those with carboxylate and sulphonate groups, such as disclosed in U.S. Pat. No. 3,397,989, being particularly preferred. The polyester-polyurethanes preferably contain a linear polyester with OH-end groups and a molecular weight between 300 and 2,000. The polyester-polyurethanes are preferably employed as an aqueous dispersion, with a particularly preferred dispersion containing the reaction products of the following components with respect to the end dispersion: 23% by weight of a polyester based on adipic acid and hexandiol with an average molecular weight of 840, 14% by weight 4,4′-diisocyanatodicyclohexylmethane, 2% by weight dimethylolpropionic acid and 1.5% by weight of trimethylamin, with the composition further containing 7.5% by weight N-Methyl-pyrrolidon and 52% by weight water. Said particularly preferred dispersion is called hereinafter dispersion (D-1).

Suitable polyester-polyurethane dispersions include Dispercoll® products from BAYER.

Suitable colloidal silica's include products marketed under the trade names LUDOXO (Du Pont), SYTONO (Du Pont) and KIESELSOLE® (Bayer). Their average particle size is preferably between 5 and 100 nm.

Suitable siloxanes are represented by the formula:

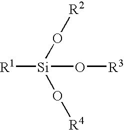

in which R¹ represents a polymerizable group or has a OH- and/or NH₂- group which can react with the protein-containing colloid, particularly a group which contains a reactive halogen, an epoxy group or an a, β-ethylenically unsaturated group. Examples of R¹ are: ClCH₂CONH—A—; BrCH₂CONH—A—; CH₂═CH(CH₃)COO—A—; CH₂═CHSO₂CH₂OCH₂SO₂NH—A—; CH₂═CHCONH—A—; CH₂⊚C(CH₃)CONH—A—;

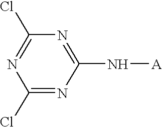

in which A represents an alkylene group, or

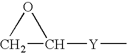

and in which Y represents a bivalent hydrocarbon chain, which can be interrupted by oxygen. R², R³ and R⁴ independently represent an optionally substituted hydrocarbon group such as methyl or ethyl.

Suitable siloxane compounds include:

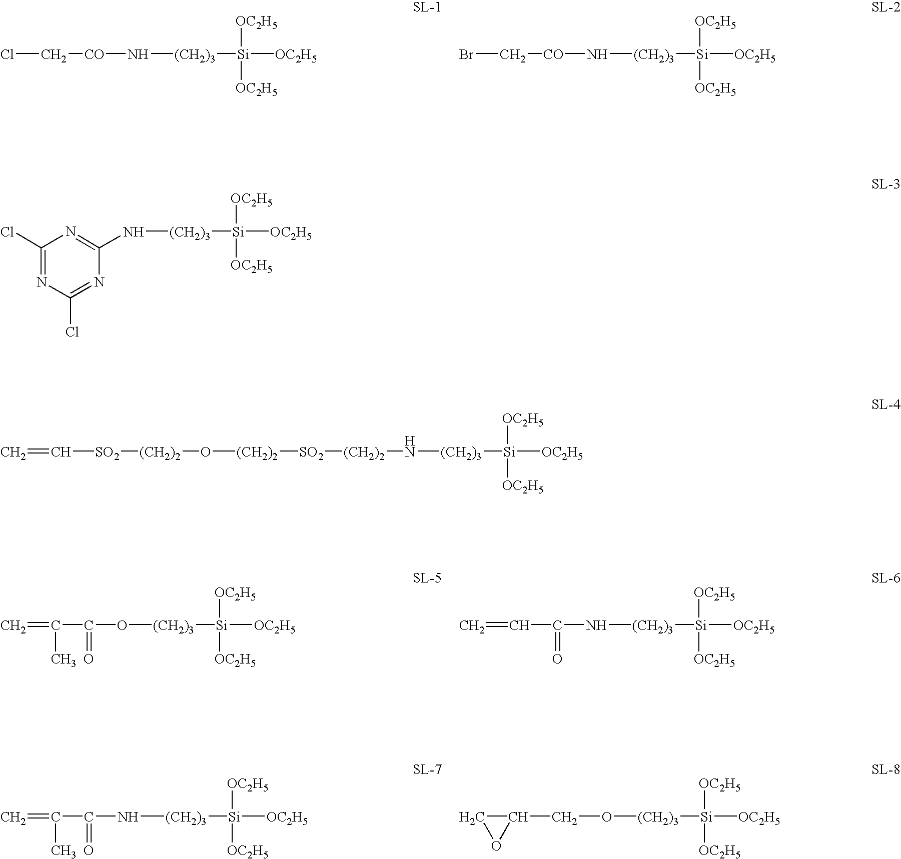

The adhesion of the subbing layer to the support can be improved by corona-pretreatment of the support. A surfactant (wetting agent) can be added to the subbing layer coating composition to improve the wetting of the subbing layer.

Suitable wetting agents include those containing saponines and products marketed under the trade names TERGITOL® (supplied by Union Carbide Corp. and Niacet Corp.) or Manoxol® (supplied by e.g. Rohm and Haas).

In respect of support materials and subbing layers EP-A 0 276 506 and EP-A 490 416 are herein incorporated by reference.

In a further preferred embodiment of the deformable color photographic silver halide material, according to the present invention, the deformable plastic support is laminatable e.g. by coating the backside of the support with an adhesive layer suitable for pressure and/or heat adhesion processes. Such pressure sensitive adhesive layers are preferably covered with a protective foil. The adhesive layer, with or without protective foil, can be applied to the support at any time before lamination, thus even before the coating of the support with light-sensitive layers. It is preferred to apply the adhesive layer after processing the color photographic material.

### Provision of a Protective Foil on the Outermost Layer of the Image Side of the Support

In a preferred embodiment of the deformable color photographic silver halide material, according to the present invention, the outermost on the image side of the deformable color photographic material is provided with a protective foil, preferably via an adhesive layer, which, for example, protects the image from scratching and environmental effects due to oxygen, UV-light and water. The protective foil provided on the image side of the support preferably comprises homopolymers such as PVC, PC, a polyalkylene or a polyester such as PET or COPET, in particular PVC. The protective foil can also comprise block copolymers with polymer subunits that are preferably selected from the aforementioned homopolymers; mixed copolymers obtained by mixed polymerization of at least two monomers, in particular of at least two different vinyl monomers such as a vinylchloride, an alkylene or a styrene; or blends of at least two polymers selected from the aforementioned homopolymers and/or block copolymers and/or mixed copolymers.

In a preferred embodiment of the present invention, the adhesive layer is a polyalkylene foil (adhesive foil), in particular a polyethylene foil, that can be laminated in direct contact to the protective foil or that is adhered to the protective foil using a glue layer.

Preferably the protective foil and/or the adhesive layer and/or the glue layer if present contain a UV-absorber such as hydroxybenzophenone or hydroxybenzotriazole. Preferred UV-absorber are those known under the trade name Tinuvin and are delivered by Ciba-Geigy. Suitable protective foils, adhesives and glues include those disclosed in EP-A 0 348 310, U.S. Pat. Nos. 4,456,667, 4,455,359, 4,378,392, 4,370,397, 3,871,119 and GB-A 2,321,977 herein incorporated by reference. The protective foil can consist of a single polymer composition or can be a mixture or a laminate of the same or different polymers, taken from the group of PVC, PC, PET, COPET or a polyalkylene. It is preferred, that at least one of the polymers used for the protective foil is of the same plastic material that is used for the support.

In a preferred embodiment of the protective foil used for the material, according to the present invention, the protective foil has a T_{g} that is similar to the T_{g} of the deformable plastic support. Particularly preferred adhesive foils of polyethylene have a melting point of ca. 90 to 100° C.

In a further preferred embodiment of the protective foil used for the material, according to the present invention, the protective foil can be coloured and/or printed with any kind of design, image or text.

The sandwich of protective foil, optionally a glue layer and the adhesive layer is preferably laminated to the image side of the photographic material using a roller laminator.

According to a preferred embodiment of the process, according to the present invention, the deformable color photographic silver halide material is provided with a protective foil before deforming the color photographic material with a work piece.

### Deformation of the Color Photographic Material

The deformation of the color photographic material usually is carried out after conventional processing of the exposed color photographic material, but can also be done before processing and even before exposure. However, it is preferred to carry out the deformation after conventional processing of the exposed color photographic material.

According to a preferred embodiment of the process, according to the present invention, the deforming step comprising the application of heat and pressure and wherein at least part of the deformable color photographic material is elongated during the process. The tool used in the deformation step can, for example, be a mould into which the heated plastic is sucked, blown or pressed. In the furniture industry, for example, the piece of furniture to which the color photographic material is to be applied, can itself be the shaping tool. In this case the shaping tool is termed the “work piece”. The color photographic material is thereby pressed onto the piece of furniture (the work piece), for example with the aid of a membrane press, and thereby intimately attached to the piece of furniture. In this process the work piece covered with the photographic material is pressed onto an elastic membrane (usually made of rubber) which itself is placed on top of a tank completely filled with hot water of about 95° C. or filled with hot oil to enable the process, according to the present invention, to be carried out at higher temperatures.

According to a preferred embodiment of the process, according to the present invention, the deforming step comprises deforming the deformable color photographic material by vacuum deformation.

Adhesion of the deformed color photographic material to the piece of furniture is preferably supplemented with an adhesive. In the case of very soft materials deformable at room temperature (25° C.) a pressure adhesive is sufficient (e.g. a contact adhesive). The piece of furniture, e.g. a piece of chipwood, has only been taken as an example. The deformable color photographic material, according to the present invention, can easily been used in other technical areas, e.g. the automotive industry, by just replacing the work piece and using adhesives that are known to work for the material the work piece is made of.

According to a preferred embodiment of the process, according to the present invention, the deforming step comprises deforming the deformable color photographic material by injection moulding, wherein the photographic material is placed in a die mould and the injected plastic material deforms the photographic material and forms a single entity with the deformable color photographic material.

In a preferred embodiment of the process, according to the present invention, the deforming step comprises deforming the deformable color photographic material in contact with a work piece Usually the support side of the deformable color photographic material is applied to the work piece e.g. a piece of furniture. In this case it is preferable that the image side of the processed color photographic material is provided with a transparent protective foil as described above just before the deformation step so as to prevent damage during the deformation step.

If the support is clear or at least transparent and not too strongly coloured, the silver halide emulsion-side of the deformable color photographic material can be applied to the work piece. In such cases, in addition to the usual cold and hot-melt adhesives, a gelatin solution containing a gelatin-hardening agent can also be used as an adhesive. Instead of adhering the silver halide emulsion-side directly to the work piece, a preferably reflective, e.g. white or opaque protective foil can be placed in between the silver halide emulsion side of the color photographic material and the work piece.

In a preferred embodiment of the present invention, the adhesion of the deformed photographic material to the work piece is further improved, particularly at the corners and edges of the work piece and where the deformed material ends, e. g. at the corners and the edges on the back side of a piece of furniture. This can be carried out by pretreatment of the work piece, particularly at the corners and edges, with a glue before the deformation; or processing the work piece coated with the deformable photographic material with a hot-knife and/or applying glue after deformation and if necessary after having cut-off surplus photographic material to seal the corners and edges and to prevent peeling of the deformed material.

### Color Photographic Material

In a preferred embodiment of the color photographic silver halide material according to the present invention, a color photographic silver halide material able to undergo deformation without significant image degradation is provided, the color photographic silver halide material comprising on a deformable plastic support at least one blue-sensitive silver halide emulsion layer containing at least one yellow coupler, at least one green-sensitive silver halide emulsion layer containing at least one magenta coupler and at least one red-sensitive silver halide emulsion layer containing at least one cyan coupler, wherein the silver halide emulsions have an overall silver chloride content of at least 95 mol % and at least one silver halide emulsion contains silver halide crystals that are doped with 10 to 700 nmol iridium.

In a further preferred embodiment of the present invention, the silver halide emulsions have an overall silver chloride content of at least 98 mol %. Silver halide emulsions which are substantially free from silver iodide are preferred, emulsions with less than 1 mol % iodide and in particular emulsions with less than 0.1 mol % iodide being particularly preferred.

At least one silver halide emulsion used in the material, according to the present invention, preferably contains silver halide crystals that are doped with at least one dopant alone or in addition to Ir. For silver halide crystals with a high silver chloride content the preferred dopants in addition to Ir are Rh- and Hg-salts.

It is particularly preferred, that at least one blue-, at least one green- and at least one red-sensitive silver halide emulsion layer in each case comprises at least one silver halide emulsion whose silver halide crystals are doped with at least 10 to 700 nmol, preferably 10 to 500 nmol Ir.

Preferably the silver halide crystals are doped with Ir in form of Ir(IV)-salts or complexes, particularly with salts or complexes comprising halide ions such as chloride or fluoride, acetate ions, or ligands such as nitrosyl or 5-methyl thiazole.

Suitable dopants for the emulsions used in the material of the present invention and processes for the addition of the dopants are to be found in Research Disclosure 37038, parts XV-B (1995), from page 90 herein incorporated by reference.

The silver halide emulsions used in the color photographic material of the present invention, can be prepared by a simple double jet process, a double jet process with separate preprecipitation (formation of crystal nuclei) and precipitation thereon or a combined double jet recrystallization process. In a preferred embodiment of the material according to the present invention, the preparation of at least one silver halide emulsion used for the material comprises the recrystallization of a Lippmann (mikrate) emulsion.

In a preferred embodiment, according to the present invention, the Ir dopants are added to the halide solution, when preparing the emulsions by a simple double jet process and added to the Lippmann emulsion, when a Lippmann emulsion (mikrate) recrystallization process is used.

At least one silver halide emulsion preferably contains silver halide crystals with at least two different zones (structured crystals), in which the outermost zone has a higher molar content of silver bromide than the rest of the crystal. The nucleus of the structured crystals is preferably prepared by a double jet process with a silver nitrate solution and a halide solution, predominantly chloride, and precipitation thereon preferably occurs by recrystallization of a fine-grained silver bromide-chloride emulsion (Lippmann emulsion) with a molar silver bromide content of at least 5 percent.

According to a preferred embodiment of the deformable color photographic silver halide material, according to the present invention, at least one silver halide emulsion contains structured crystals with at least two different zones, the outermost zone having a higher molar content of silver bromide than the rest of the crystal.

According to another preferred embodiment of the deformable color photographic silver halide material, according to the present invention, at least one blue-, at least one green- and at least one red-sensitive silver halide emulsion layer in each case comprises at least one silver halide emulsion which contains the structured crystals.

According to another preferred embodiment of the deformable color photographic silver halide material, according to the present invention, the green-sensitive silver halide emulsion layer and/or the red-sensitive silver halide emulsion layer contains at least one silver halide emulsion with silver halide crystals having an average grain size (volume averaged, diameter of a sphere with an equivalent volume) of at least 0.40 μm.

According to another preferred embodiment of the deformable color photographic silver halide material, according to the present invention, the silver halide emulsions contain one or more binders, with the binders being at least 80% by weight of gelatin being particularly preferred.

In a preferred embodiment of the color photographic material, according to the present invention, yellow couplers, purple couplers and blue-green couplers represented by formulae (IV), (V), (VI), (XIV), (VII) and (VIII) are used.

Yellow Coupler

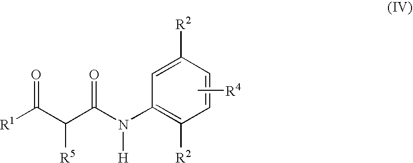

wherein

R¹ represents alkyl, alkoxy, aryl or hetero-aryl groups,

R² represents alkoxy or aryloxy groups or halogen,

R³ represents —CO₂R⁶, —CONR⁶R⁷, —NHCO₂—R⁶, —NHSO₂—R⁶, —SO₂NR⁶R⁷, —SO₂NHCOR⁶, —NHCOR⁶ groups, Cl

R⁴ represents hydrogen or a substituent,

R⁵ represents hydrogen or a group which can be split off during coupling,

R⁶, R⁷ independently represent hydrogen or alkyl or aryl groups and one of the R², R³ and R₄ group is a ballast group.

Magenta Coupler

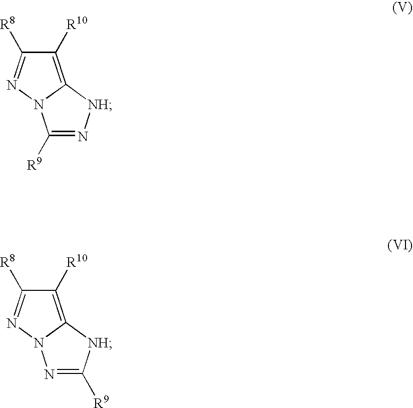

wherein

R⁸ and R⁹ independently represent hydrogen or alkyl, aralkyl, aryl, aryloxy, alkylthio, arylthio, amino, anilino, acylamino, cyano, alkoxycarbonyl, alkylcarbamoyl or alkylsulfamoyl groups, wherein these groups are optionally further substituted and wherein at least one of these groups contains a ballast group, and

R¹⁰ represents hydrogen or a group which can split off during chromogenic coupling.

R⁸ is preferably a tert.-butyl group; R¹⁰ is preferably chlorine.

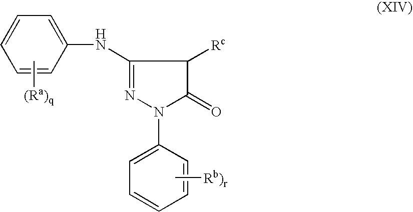

wherein r is an integer from 1 to 5; q is 1, 2 or 3; R^{c} represents a group which can split off during chromogenic coupling; R^{a} represents halogen oralkoxy or acylamino groups; and R^{b} represents halogen or cyano, thiocyanato, alkoxy, alkyl, acylamino or alkoxycarbamyl groups.

R^{c} is preferably hydrogen or a group which can split off as an anion under the basic conditions of chromogenic coupling.

Particularly preferred, R^{c} represents —S-aryl or —N═N-aryl, wherein aryl preferably is a phenyl or naphthyl group, that is optionally substituted by halogen, like chlorine or bromine or C₁-C₁₈-alkyl or C₁-C₁₈-alkoxy groups.

Cyan Coupler

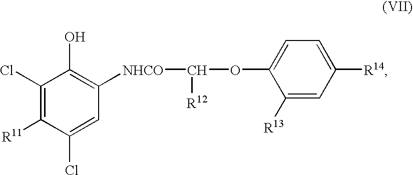

wherein R¹¹, R¹², R¹³ and R¹⁴ independently represent hydrogen or a C₁-C₆-alkyl group. R¹¹ is preferably a CH₃ or C₂H₅; R¹² is preferably a C₂-C₆-alkyl group; and R¹³ and R¹⁴ are preferably t-C₄H₉ or t-C₅H₁₁.

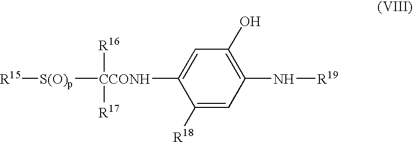

wherein R¹⁵ represents alkyl, alkenyl, aryl or hetero-aryl groups; R¹⁶, R¹⁷ independently represent hydrogen, alkyl, alkenyl, aryl or hetero-aryl groups; R¹⁸ represents hydrogen or a group which can split off during chromogenic coupling; R¹⁹ represents —COR²⁰, —CO₂R²⁰, —CONR²⁰R²¹, —SO₂R²⁰, —SO₂NR²⁰R²¹, —CO—CO₂R²⁰, —COCONR²⁰R²¹ or a group with the formula

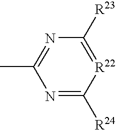

wherein R²⁰ represents alkyl, alkenyl, aryl or hetero-aryl groups; R²¹ represents hydrogen or R²⁰; R²² represents —N═ or —C(R²⁵)═; R²³, R²⁴ and R²⁵ independently represent —OR²¹, —SR²¹, —NR²⁰R²¹, —R²¹ or Cl; and p is 1 or 2.

The following groups of couplers according to formula (VIII) are preferred:

(1) couplers in which p=1 and R¹⁵ to R²⁵ have the meaning given above.

(2) couplers in which p=2, R¹⁹ represents —CO—R²⁶, R²⁶ represents alkenyl or hetero-aryl groups and R¹⁵ to R¹⁸ have the meanings given above.

(3) couplers in which p=2, R¹⁹ represents —SO₂R²⁷, —SO₂N(R²⁷)₂, —CO₂R²⁷, —COCO₂—R²⁷, or —COCO—N(R²⁷)₂, R²⁷ represents alkyl, aryl, alkenyl or hetero-aryl groups and R¹⁵ to R¹⁸ have the meanings given above.

(4) couplers in which p=2, R¹⁹ represents a group with the formula

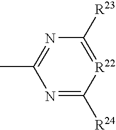

and R¹⁵ to R¹⁸ and R²² to R²⁴ have the meanings given above.

(5) couplers in which p=2 and R¹⁹ represents a group with the formula

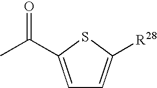

R²⁸ represents hydrogen, Cl, CN, Br, F, —COR²⁹, —CONHR²⁹ or CO₂R²⁹ and R²⁹ represents alkyl or aryl groups.

(6) couplers in which p=2 and R¹⁹ represents a group with the formula

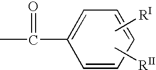

wherein R^{I} represents halogen, CN, —CF₃ or alkoxycarbonyl groups; R^{II} represents hydrogen or has the same meaning as R^{I}; and R¹⁵ to R¹⁸ have the meanings given above.

(7) couplers in which p=2 and R¹⁹ represents —COR²⁰; R²⁰ represents alkyl, aryl or hetero-aryl groups and R¹⁵ to R¹⁸ have the meanings given above.

(8) couplers in which p=2 and R¹⁹ represents a group with the formula

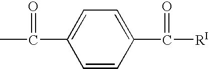

wherein R^{I} represents —OR^{II} or —NR^{III}R^{IV}; R^{II} and R^{III} represent an optionally substituted C₁-C₆-alkyl group; R^{IV} represents hydrogen or has the same meaning as R^{III}; and R¹⁵ to R¹⁸ have the meanings given above.

In the formula (VIII) and the Compounds (1) to (8) the substituents have the following preferred meanings: R¹⁵ represents alkyl or aryl groups; R¹⁶ and R¹⁷ independently represent H or alkyl or aryl groups; R¹⁸ represents H, Cl, alkoxy, aryloxy, alkylthio or arylthio groups; R²² represents —N=; and R²³ and R²⁴ independently represent —OR²¹, —NR²⁰R²¹ or —Cl.

In formula (VIII) and the Compounds (1) to (8) the substituents have the following particularly preferred meanings: R¹⁵ is a group according to one of formulae (15-1), (15-2) and (15-3):

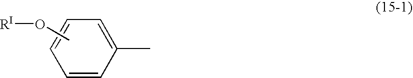

wherein R^{I} represents an alkyl group with at least 8 C-atoms;

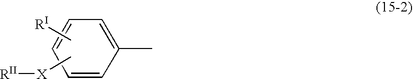

wherein R^{I} represents alkyl, alkenyl, alkoxy, aryloxy, acyloxy, acylamino, sulfonyloxy, sulfamoylamino, sulfonamido, ureido, hydroxycarbonyl, hydroxy, carbonylamino, carbamoyl, alkylthio, arylthio, alkylamino, arylamino groups or hydrogen; R^{II} represents an alkyl or aryl group; X represents S, NH or NR^{III} and R^{III} represents an alkyl or aryl group;

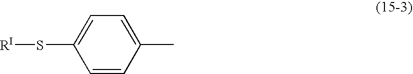

wherein R^{I} represents an optionally substituted alkyl group; R¹⁶ represents an alkyl group, in particular C₁-C₄-alkyl group; R¹⁷ represents H; and R²⁰ represents an alkyl or aryl group.

Particularly preferred couplers are group (6) couplers according to formula (VIII) in which Ris is represented by formula (15-1); group (7) couplers according to formula (VIII) in which R¹⁵ is represented by formula (15-2); group (8) couplers according to formula (VIII) in which R¹⁵ is represented by formula (15-3); and group (8) couplers according to formula (VIII) and R¹⁵ is a group with 8 to 18 carbon atoms.

Alkyl- and alkenyl- groups can be straight chain, branched, cyclic and optionally substituted. Aryl- and hetero-aryl- groups are optionally substituted and the aryl group is preferably a phenyl group. Possible substituents for the alkyl, alkenyl, aryl and hetero-aryl groups are: alkyl, alkenyl, aryl, hetero-aryl, alkoxy, aryloxy, alkenyloxy, hydroxy, alkylthio, arylthio, halogen, cyano, acyl, acyloxy or acylamino groups, wherein an acyl group can be derived from an aliphatic, olefinic or aromatic carbonic, carboxylic, carboxylamino, sulfonic, sulfonamido, sulfinic, phosphoric, phosphonic or phosphorous acid.

Examples of cyan couplers according to formula (VII) are:

VII-1 with R¹¹=C₂H₅, R¹²=n-C₄H₉, R¹³=R¹⁴=t-C₄H₉,

VII-2 with R¹¹=R¹²=C₂H₅, R¹³=R¹⁴=t-C₅H₁₁,

VII-3 with R¹¹=C₂H₅, R¹²=n-C₃H₇, R¹³=R¹⁴=t-C₅H₁₁,

VII-4 with R¹¹=CH₃, R¹²=C₂H₅, R¹³=R¹⁴=t-C₅H₁₁.

Examples of cyan couplers according to formula (VIII) with p=2 are:

| No. | R¹⁶ | R¹⁷ | R¹⁵ | R¹⁹ | R¹⁸ |
|---|---|---|---|---|---|
| VIII-1 | —C₂H₅ | H | 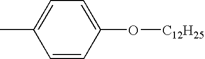 | 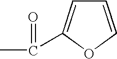 | —Cl |
| VIII-2 | —C₂H₅ | H | 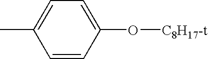 | 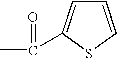 | —H |
| VIII-3 | —C₆H₁₃ | H | 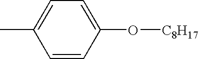 | 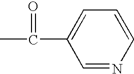 | —OCH₂CH₂—SCH₂COOH |
| VIII-4 | -Phenyl | H | 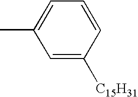 | 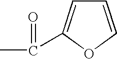 | —Cl |
| VIII-5 | —CH₃ | —CH₃ | —C₁₆H₃₃ | 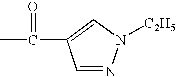 | —Cl |
| VIII-6 | -Phenyl | H | —CH₁₂H₂₇ | 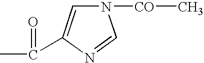 | —SCH₂CH₂—COOH |
| VIII-7 | —C₂H₅ | H | 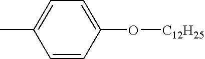 | 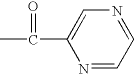 | —O—CH₂—COOCH₃ |
| VIII-8 | —C₁₂H₂₅ | H | 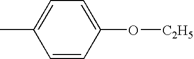 | 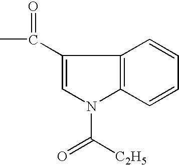 | —Cl |
| VIII-9 | —C₃H₇-i | H | 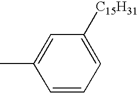 | 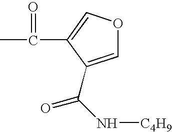 | —Cl |
| VIII-10 | —CH₃ | —CH₃ | 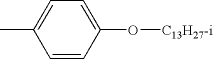 | 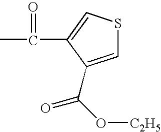 | 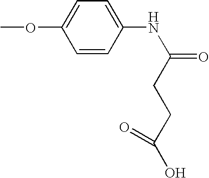 |
| VIII-11 | —C₂H₅ | H | 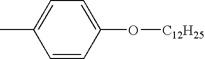 | 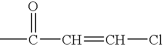 | —Cl |
| VIII-12 | -phenyl | H | —C₁₆H₃₃ | 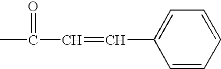 | H |
| VIII-13 | —C₁₂H₂₅ | H | 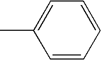 | 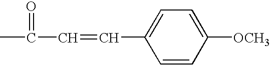 | —Cl |
| VIII-14 | —C₄H₉ | H | 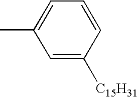 | 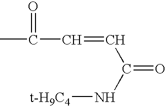 | —OCH₂COOH₃ |
| VIII-15 | —CH₃ | —CH₃ | 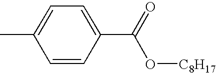 | 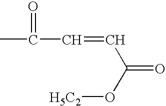 | —Cl |
| VIII-16 | —C₂H₅ | H | 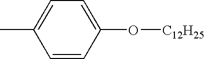 | —SO₂—C₄H₉ | —Cl |
| VIII-17 | —C₂H₅ | H | 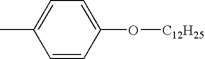 | —CO—O—C₄H₉-i | —Cl |
| VIII-18 | —C₃H₇-i | H | 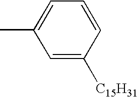 | 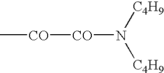 | —OCH₂—COOCH₃ |
| VIII-19 | -phenyl | H | 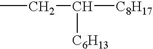 | —SO₂—NH—C₄H₉—t | H |
| VIII-20 | —C₆H₁₃ | H | 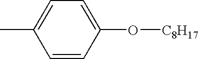 | 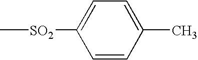 | H |
| VIII-21 | —CH₃ | —CH₃ | 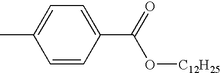 | —CO—CO—OC₂H₅ | —Cl |
| VIII-22 | —C₄H₉ | H | 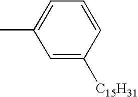 | —SO₂—CH₃ | —Cl |
| VIII-23 | -phenyl | -phenyl | —C₁₂H₂₅ | —SO₂—C₄H₉ | —SCH₂CH₂—COOH |
| VIII-24 | —C₁₂H₂₅ | H | 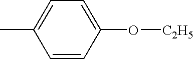 | —CO—O—C₂H₅ | —Cl |
| VIII-25 | —C₂H₅ | H | 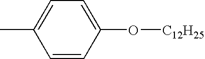 | 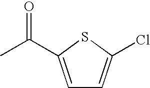 | —Cl |
| VIII-26 | —CH₃ | H | 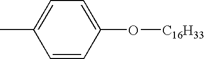 | 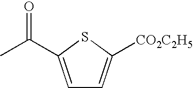 | —Cl |
| VIII-27 | —C₂H₅ | H | 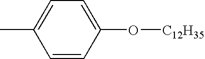 | 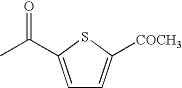 | —Cl |

Examples of cyan couplers according to formula (VIII) with p=2 and

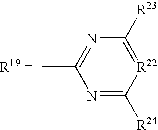

are:

| Nr. | R¹⁶ | R¹⁷ | R¹⁵ | R²³ |
|---|---|---|---|---|
| VIII-28 | —C₂H₅ | H | 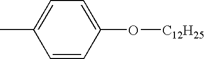 | —N(C₄H₉)₂ |
| VIII-29 | —C₂H₅ | H | 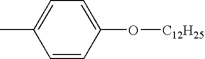 | 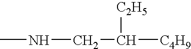 |
| VIII-30 | —C₂H₅ | H | 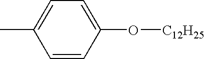 | —OCH₃ |
| VIII-31 | —C₆H₁₃ | H | 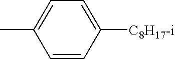 | —Cl |
| VIII-32 | -phenyl | H | —C₁₂H₂₅ | —OCH₃ |
| VIII-33 | —CH₃ | —CH₃ | 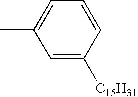 | —NH—C₄H₉ |
| VIII-34 | H | H | 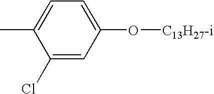 | —OCH₃ |
| VIII-35 | —CH₃ | H | 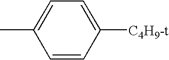 | —Cl |

| | R²⁴ | R²² | R¹⁸ |
|---|---|---|---|
| VIII-28 | —N(C₄H₉)₂ | —N═ | —C— |
| VIII-29 | 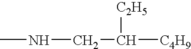 | —N═ | —Cl |
| VIII-30 | —OCH₃ | —N═ | —Cl |
| VIII-31 | —NH—C₄H₉ | —C(NHC₄H₉)= | H |
| VIII-32 | —N(C₄H₉)₂ | —N═ | —OCH₂COOCH₃ |
| VIII-33 | —NH—C₄H₉ | —C(N(C₂H₅)₂)═ | —Cl |
| VIII-34 | —NH—C₄H₉ | —N═ | S-CH₂CH₂-COOH |
| VIII-35 | 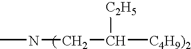 | —N═ | —Cl |

Examples of cyan couplers according to formula (VIII) with p=1 are:

| Nr. | R¹⁶ | R¹⁷ | R¹⁵ | R¹⁹ |
|---|---|---|---|---|
| VIII-36 | —C₂H₅ | H | 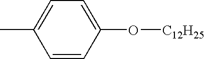 | 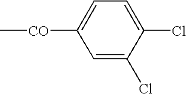 |
| VIII-37 | —C₄H₉ | H | 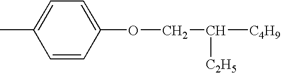 | —CO—C₃F₇ |
| VIII-38 | —C₆H₁₃ | H | 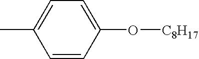 | 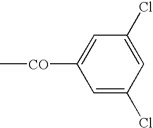 |
| VIII-39 | —CH₃ | —CH₃ | 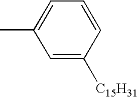 | 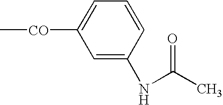 |
| VIII-40 | -Phenyl | H | 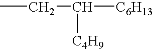 | 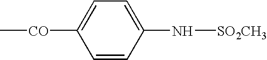 |
| VIII-41 | —C₂H₅ | H | 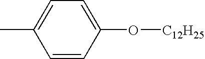 | 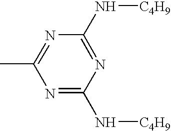 |
| VIII-42 | —C₁₂H₂₅ | H | 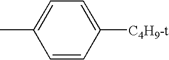 | 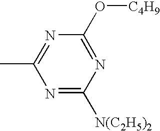 |
| VIII-43 | —C₄H₉ | H | —C₁₂H₂₅ | 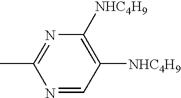 |
| VIII-44 | —C₂H₅ | H | 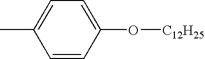 | —SO₂—C₄H₉ |
| VIII-45 | —C₃H₇-i | H | —C₁₆H₃₃ | 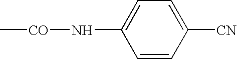 |
| VIII-46 | —CH₂CH₂CH₂CH₂— | | 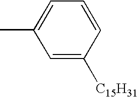 | 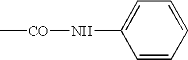 |
| VIII-47 | —C₂H₅ | —C₂H₅ | 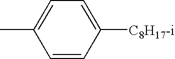 | —CO—O—C₄H₉-i |
| VIII-48 | -phenyl | H | —C₁₂H₂₅ | —CO—CO—N(C₄H₉)₂ |
| VIII-49 | —C₁₂H₂₅ | H | 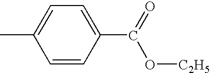 | —CO—CH═CH—CO—N(C₂H₅)₂ |
| VIII-50 | —C₂H₅ | H | 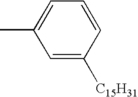 | 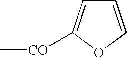 |
| VIII-51 | —C₆H₁₃ | H | 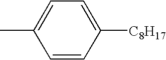 | 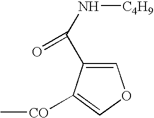 |
| VIII-52 | —C₄H₉ | H | 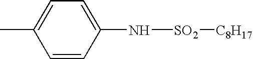 | 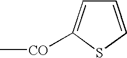 |
| VIII-53 | —CH₃ | H | 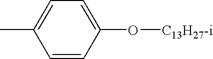 | 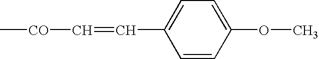 |
| VIII-54 | -Phenyl | H | 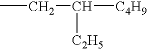 | 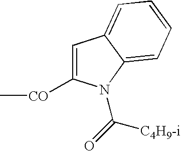 |
| VIII-55 | —C₂H₅ | H | 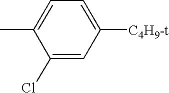 | 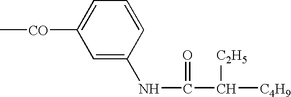 |
| VIII-56 | —C₂H₅ | H | 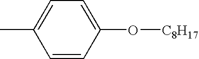 | 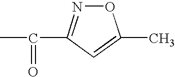 |
| VIII-57 | —C₃H₇ | H | 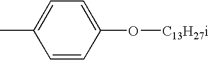 | 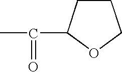 |
| VIII-58 | —C₂H₅ | H | 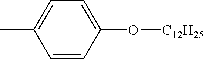 | 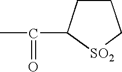 |
| VIII-59 | —H | H | 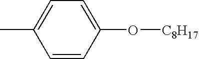 | 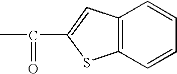 |
| VIII-60 | —C₂H₅ | H | 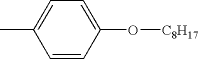 | 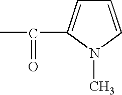 |

| | R¹⁸ |
|---|---|
| VIII-36 | —Cl |
| VIII-37 | —Cl |
| VIII-38 | —OCH₂CH₂—S—CH₂COOH |
| VIII-39 | H |
| VIII-40 | —Cl |
| VIII-41 | H |
| VIII-42 | 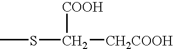 |
| VIII-43 | —Cl |
| VIII-44 | —Cl |
| VIII-45 | —O—CH₂—COO—CH₃ |
| VIII-46 | —Cl |
| VIII-47 | H |
| VIII-48 | 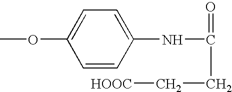 |
| VIII-49 | —Cl |
| VIII-50 | —Cl |
| VIII-51 | H |
| VIII-52 | —Cl |
| VIII-53 | —Cl |
| VIII-54 | H |
| VIII-55 | —Cl |
| VIII-56 | Cl |
| VIII-57 | Cl |
| VIII-58 | H |
| VIII-59 | Cl |
| VIII-60 | Cl |

Examples of group (6) cyan couplers according to formula (VIII) with p=2 are:

| No. | R¹⁶ | R¹⁷ | R¹⁵ | R¹⁹ | R¹⁸ |
|---|---|---|---|---|---|
| VIII-61 | —C₂H₅ | H | 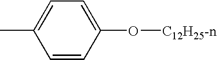 | 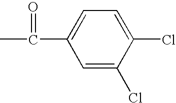 | —Cl |
| VIII-62 | —CH₃ | H | 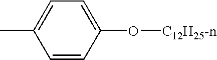 | 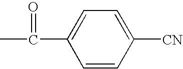 | —Cl |
| VIII-63 | —C₂H₅ | H | 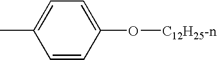 | 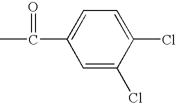 | —O—CH₂—CO—NH—CH₂—CH₂—O—CH₃ |
| VIII-64 | —C₂H₅ | H | 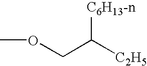 | 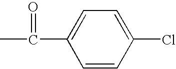 | —Cl |
| VIII-65 | —C₂H₅ | H | 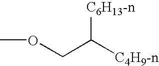 | 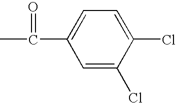 | —Cl |

Examples of group (7)cyan couplers according to formula (VIII) with p=2 are:

| No. | R¹⁶ | R¹⁷ | R¹⁵ | R¹⁹ | R¹⁸ |
|---|---|---|---|---|---|
| VIII-66 | —C₂H₅ | H | 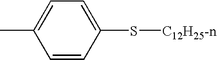 | 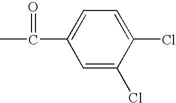 | —Cl |
| VIII-67 | —C₂H₅ | H | 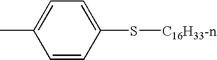 | 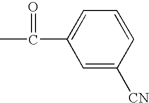 | —O—CH₂—CH₂—CO—NH—CH₃ |
| VIII-68 | —C₁₂H₂₅-n | H | 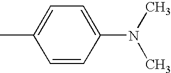 | 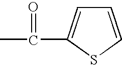 | Cl |
| VIII-69 | —C₂H₅ | H | 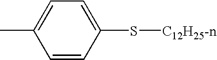 | 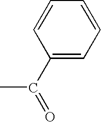 | —Cl |
| VIII-70 | —C₂H₅ | H | 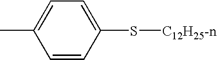 | 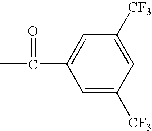 | Cl |
| VIII-71 | —C₂H₅ | H | 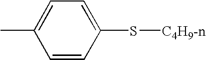 | 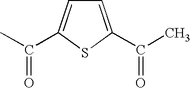 | Cl |
| VIII-72 | —C₂H₅ | H | 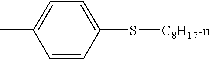 | 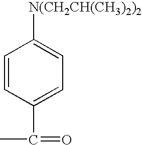 | Cl |
| VIII-73 | —C₂H₅ | H | 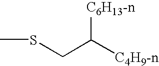 | 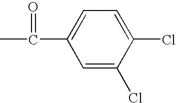 | Cl |

Examples of group (8)cyan couplers according to formula (VIII) with p=2 are:

| No. | R¹⁶ | R¹⁷ | R¹⁵ | R¹⁹ | R¹⁸ |
|---|---|---|---|---|---|
| VIII-74 | —C₂H₅ | H | 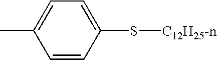 | 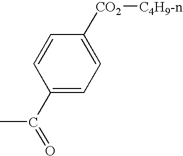 | —Cl |
| VIII-75 | —C₂H₅ | H | 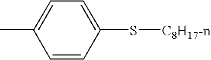 | 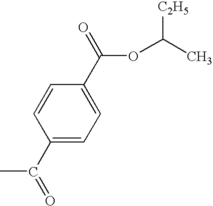 | —Cl |
| VIII-76 | —CH₃ | H | 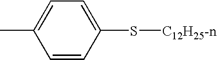 | 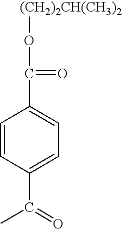 | Cl |
| VIII-77 | —C₂H₅ | H | 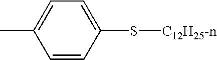 | 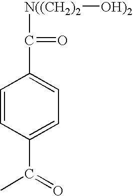 | —Cl |
| VIII-78 | —C₂H₅ | H | 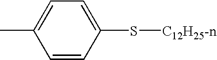 | 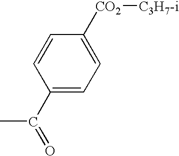 | —O—CH₂—CO—NH—CH₂—CH₂—O—CH₃ |
| VIII-79 | —C₂H₅ | H | 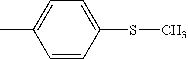 | 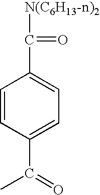 | Cl |
| VIII-80 | —CH₃ | H | 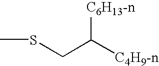 | 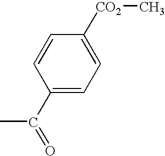 | Cl |
| VIII-81 | —C₂H₅ | H | 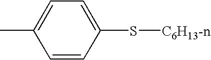 | 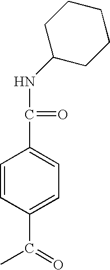 | Cl |
| VIII-82 | —C₂H₅ | H | 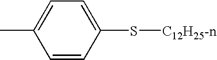 | 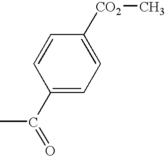 | —O—CH₂—CO—NH—CH₂—CH₂—O—CH₃ |
| VIII-83 | —C₂H₅ | H | 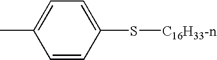 | 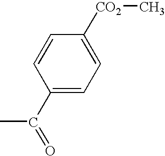 | —O—CH₂—CH₂—CO—NH—CH₃ |

The preparation of cyan couplers according to formula (VIII) proceeds analogously to the syntheses disclosed in U.S. Pat. No. 5,686,235 herein incorporated by reference.

Examples of magenta couplers according to formula (V) are:

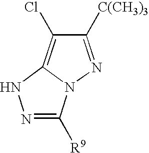

| Coupler | R⁹ |
|---|---|
| V-1 | —C₁₃H₂₇ |
| V-2 | —(CH₂)₃SO₂C₁₂H₂₅ |
| V-3 | 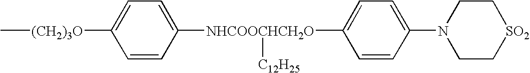 |
| V-4 | 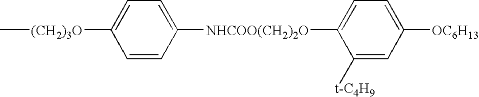 |
| V-5 | 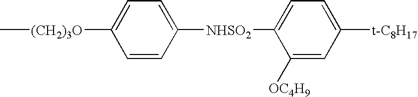 |
| V-6 | 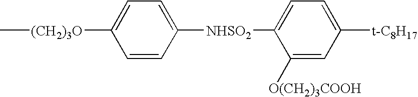 |
| V-7 | —(CH₂)₂NHCOC₁₃H₂₇ |
| V-8 | 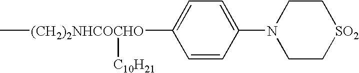 |
| V-9 | 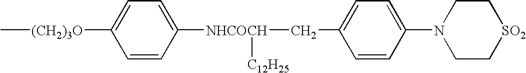 |
| V-10 | 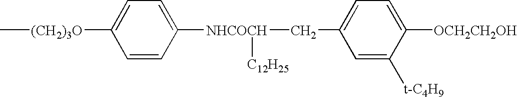 |
| V-11 | 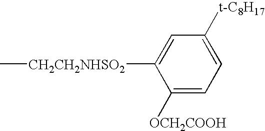 |
| V-12 | —CH₂CH₂NHSO₂C₁₆H₃₃ |
| V-13 | —CH₂CH₂NHCONHC₁₂H₂₅ |
| V-14 | —(CH₂)₃NHSO₂C₁₂H₂₅ |
| V-15 | 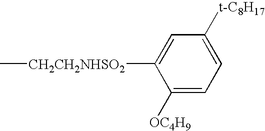 |
| V-16 | 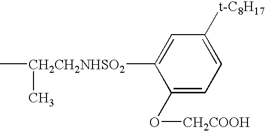 |
| V-17 | 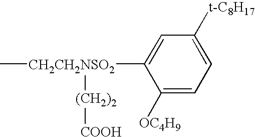 |
| V-18 | 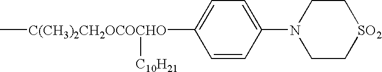 |
| V-19 | 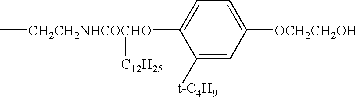 |
| V-20 | 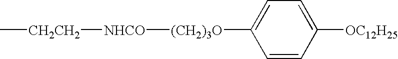 |
| V-21 | —CH₂CH₂NHCOOC₁₂H₂₅ |
| | and |
| V-22 | 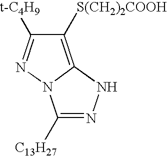 |
| V-23 | 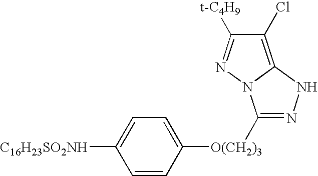 |
| V-24 | 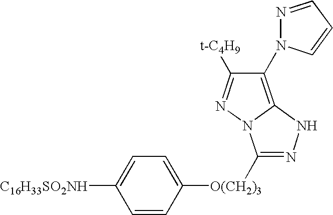 |
| V-25 | 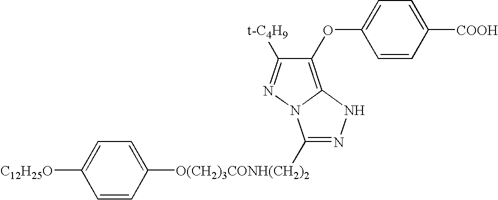 |

Examples of magenta couplers according to formula (VI) are:

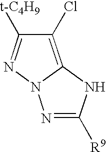

| Coupler | R⁹ |
|---|---|
| VI-1 | 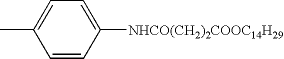 |
| VI-2 | 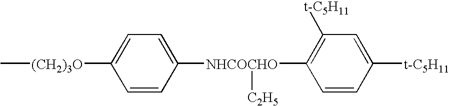 |
| VI-3 | 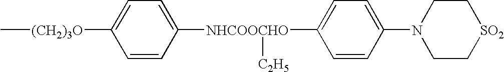 |
| VI-4 | 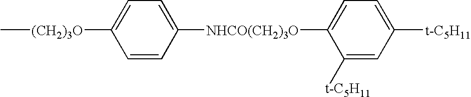 |
| VI-5 | 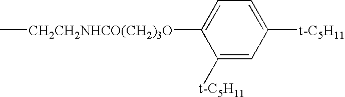 |
| VI-6 | 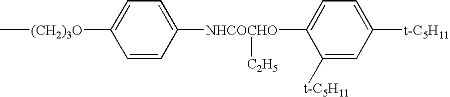 |
| VI-7 | 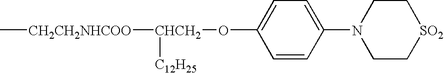 |
| VI-8 | 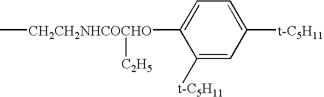 |
| VI-9 | —CH₂CH₂NHCOC₁₃H₂₇ |
| VI-10 | 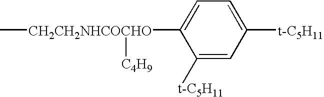 |
| VI-11 | —(CH₂)₃SO₂C₁₂H₂₅ |
| VI-12 | 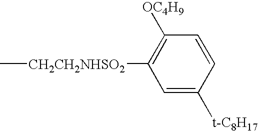 |
| VI-13 | 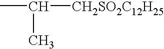 |
| VI-14 | 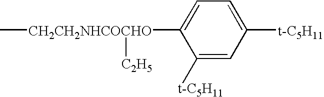 |
| VI-15 | 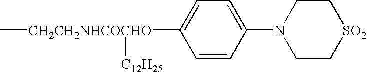 |
| VI-16 | 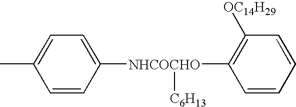 |
| VI-17 | 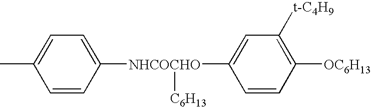 |
| | and |
| VI-18 | 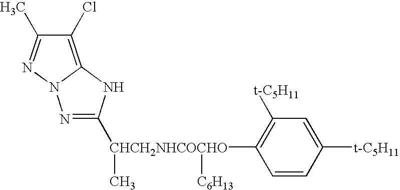 |
| VI-19 | 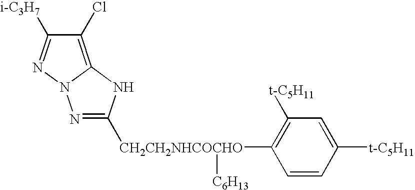 |
| VI-20 | 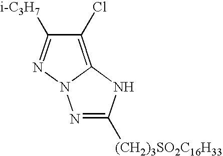 |
| VI-21 | 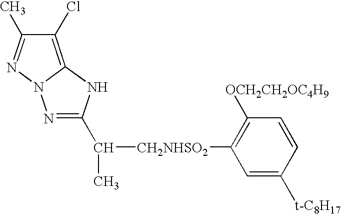 |
| VI-22 | 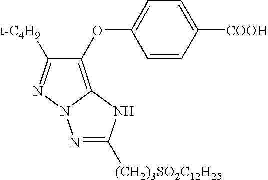 |
| VI-23 | 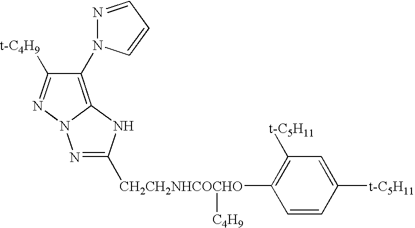 |
| VI-24 | 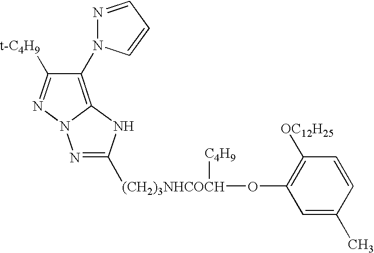 |

Examples of magenta couplers according to formula (XIV) are:

| | |
|---|---|
| Coupler | R^{c} |

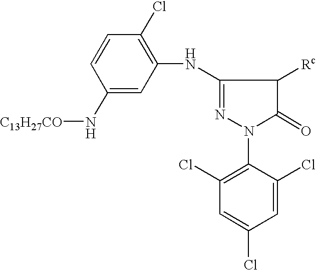

| | |
|---|---|
| (XIV-1) | —H |
| (XIV-2) | 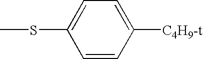 |
| (XIV-3) | 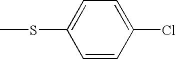 |
| (XIV-4) | 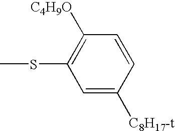 |
| (XIV-5) | 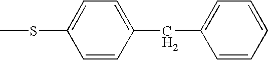 |
| (XIV-6) | 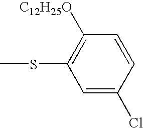 |
| (XIV-7) | 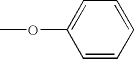 |
| (XIV-8) | 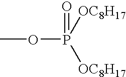 |
| (XIV-9) | —NH—SO₂—C₄H₉ |
| (XIV-10) | 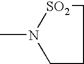 |
| (XIV-11) | 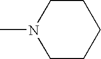 |
| (XIV-12) | 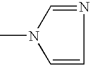 |
| (XIV-13) | 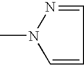 |

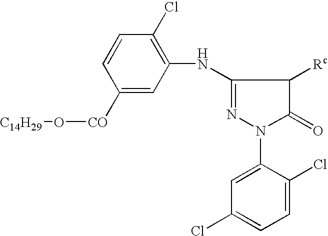

| | |
|---|---|
| (XIV-14) | H |
| (XIV-15) | 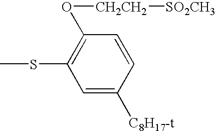 |
| (XIV-16) | 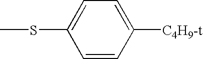 |
| (XIV-17) | 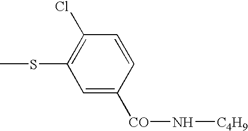 |

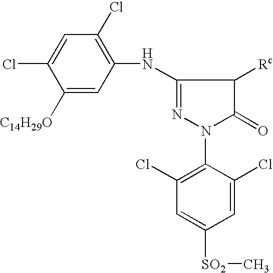

| | |
|---|---|
| (XIV-18) | H |
| (XIV-19) | 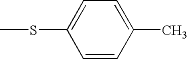 |
| (XIV-20) | 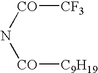 |

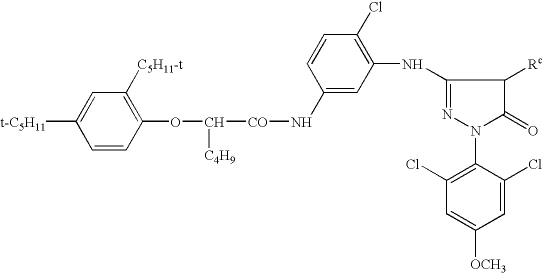

| | |
|---|---|
| (XIV-21) | H |
| (XIV-22) | 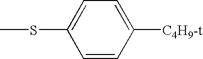 |
| (XIV-23) | 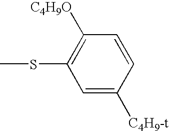 |

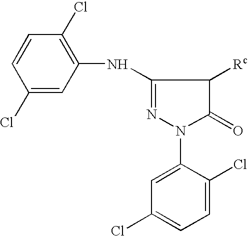

| (XIV-24) | 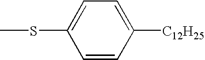 |
|---|---|
| (XIV-25) | —S—C₁₂H₂₅ |
| (XIV-26) | 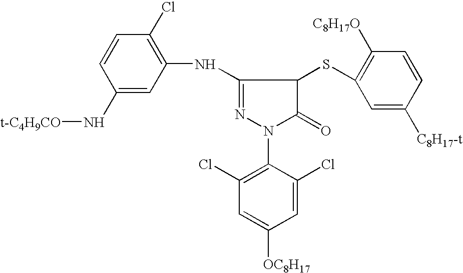 |

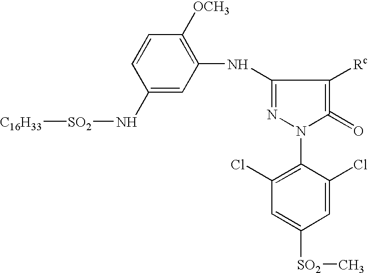

| | |
|---|---|
| (XIV-27) | H |
| (XIV-28) | 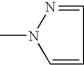 |
| (XIV-29) | 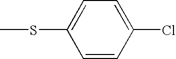 |

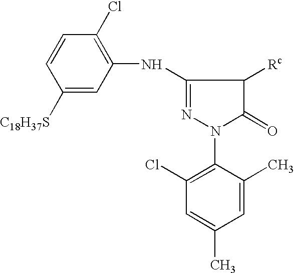

| | |
|---|---|
| (XIV-30) | H |
| (XIV-31) | 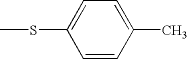 |

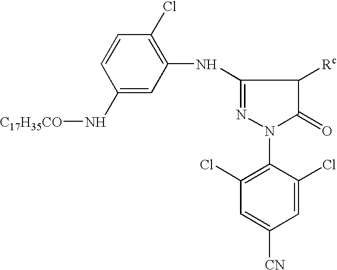

| | |
|---|---|
| (XIV-32) | H |
| (XIV-33) | 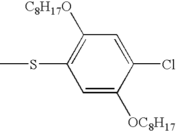 |
| (XIV-34) | 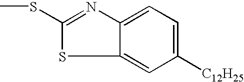 |

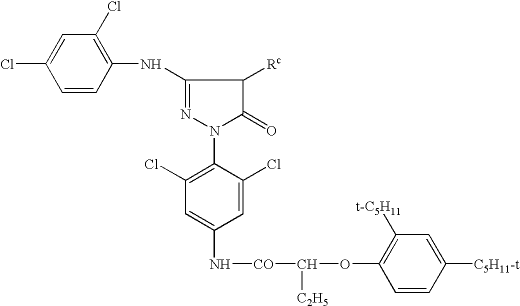

| | |
|---|---|
| (XIV-35) | H |
| (XIV-36) | 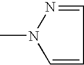 |
| (XIV-37) | 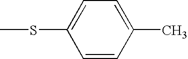 |

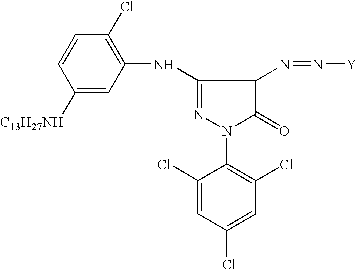

| (XIV-38) | 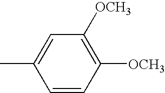 |
|---|---|
| (XIV-39) | 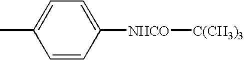 |
| (XIV-40) | 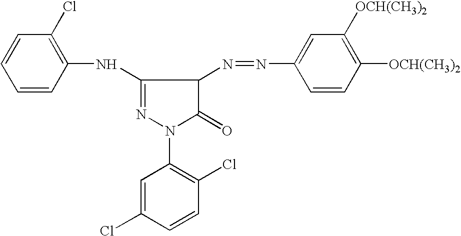 |
| (XIV-41) | 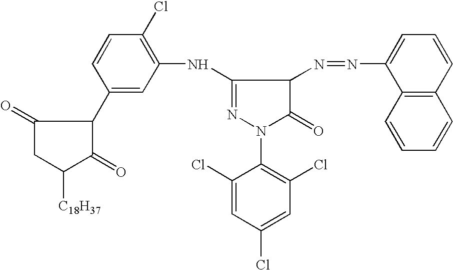 |
| (XIV-42) | 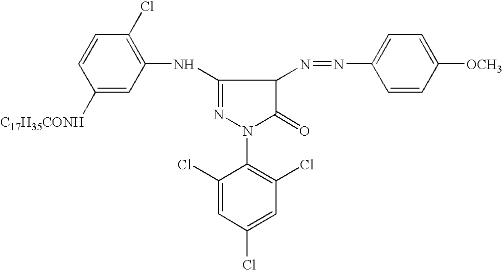 |
| (XIV-43) | 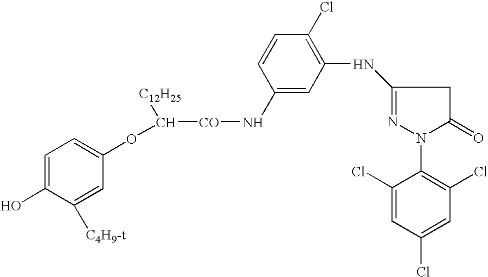 |

Examples of yellow couplers according to formula (IV) are:

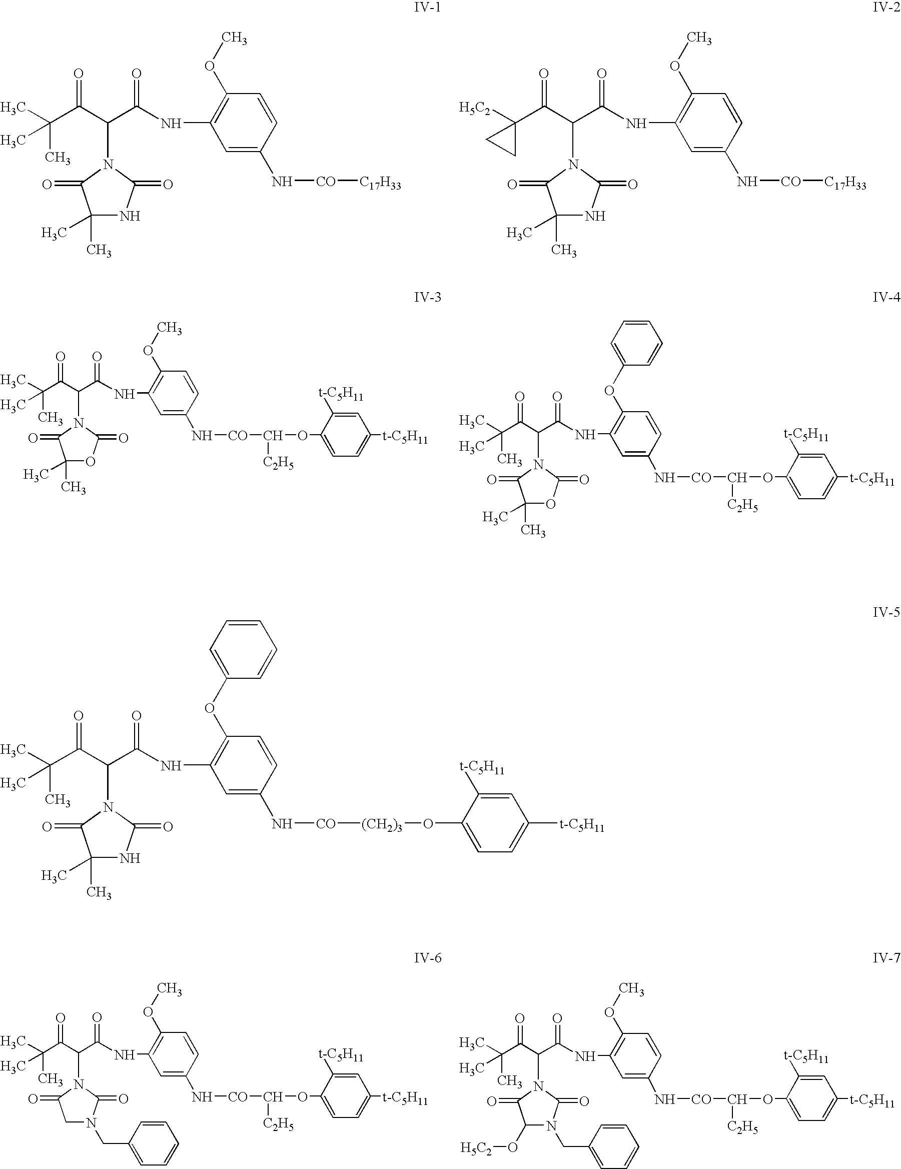

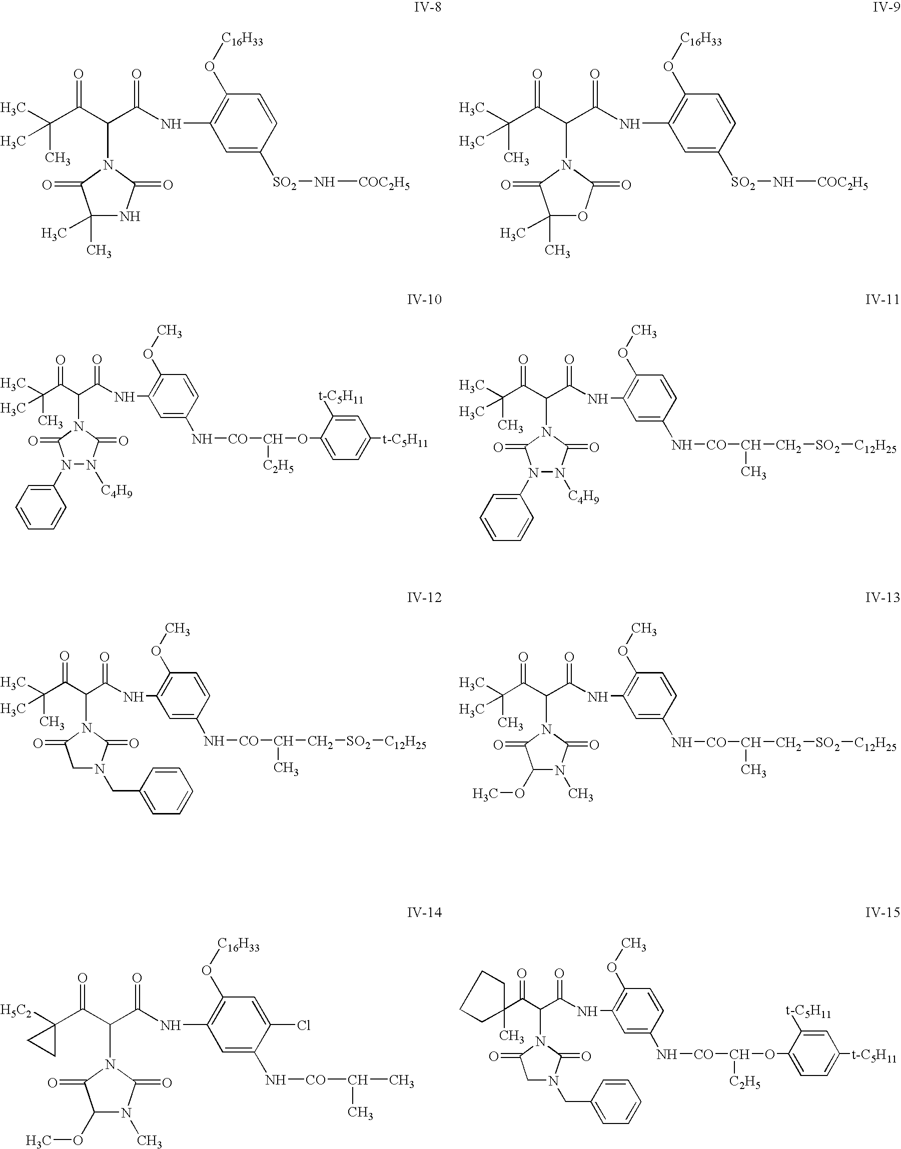

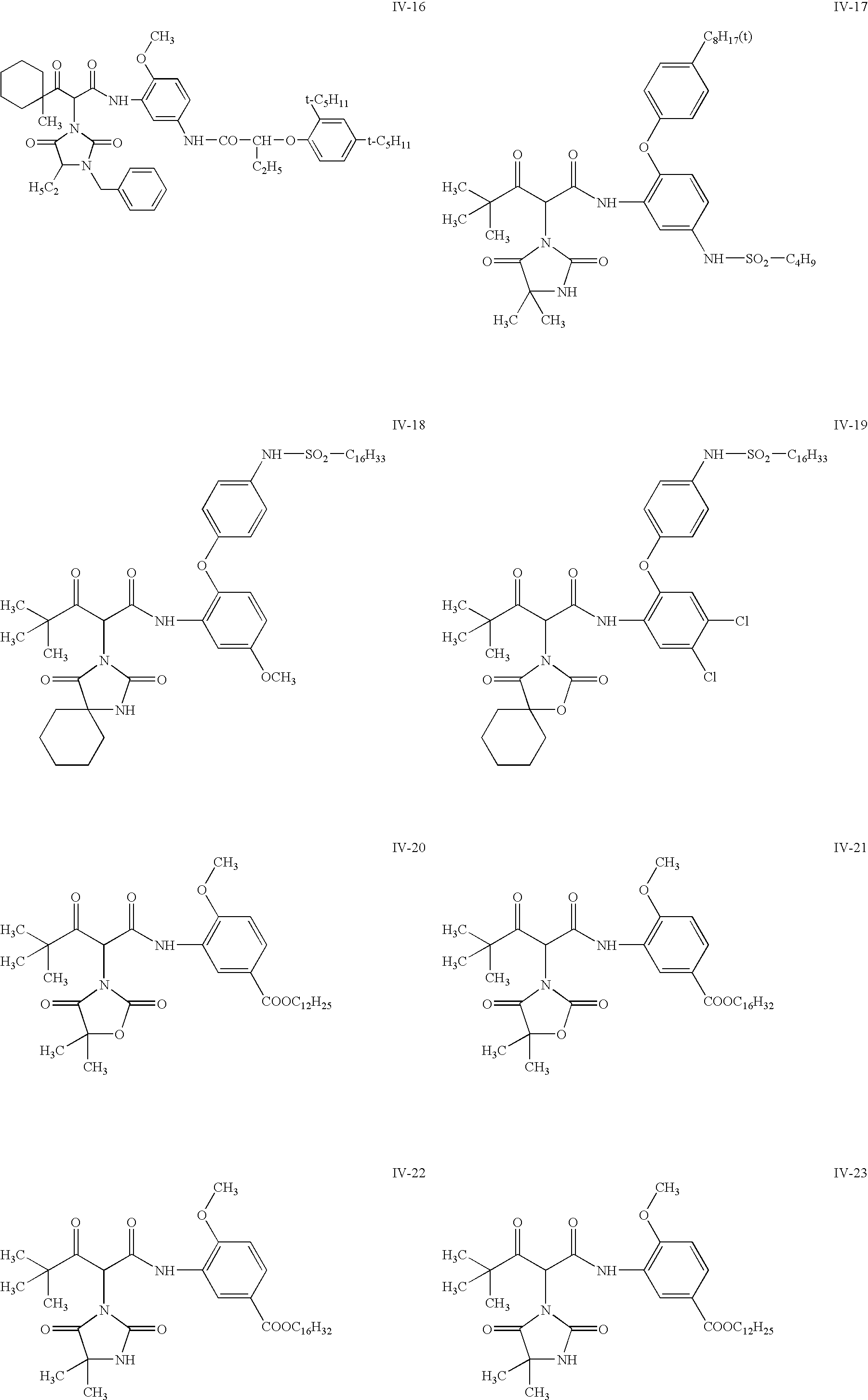

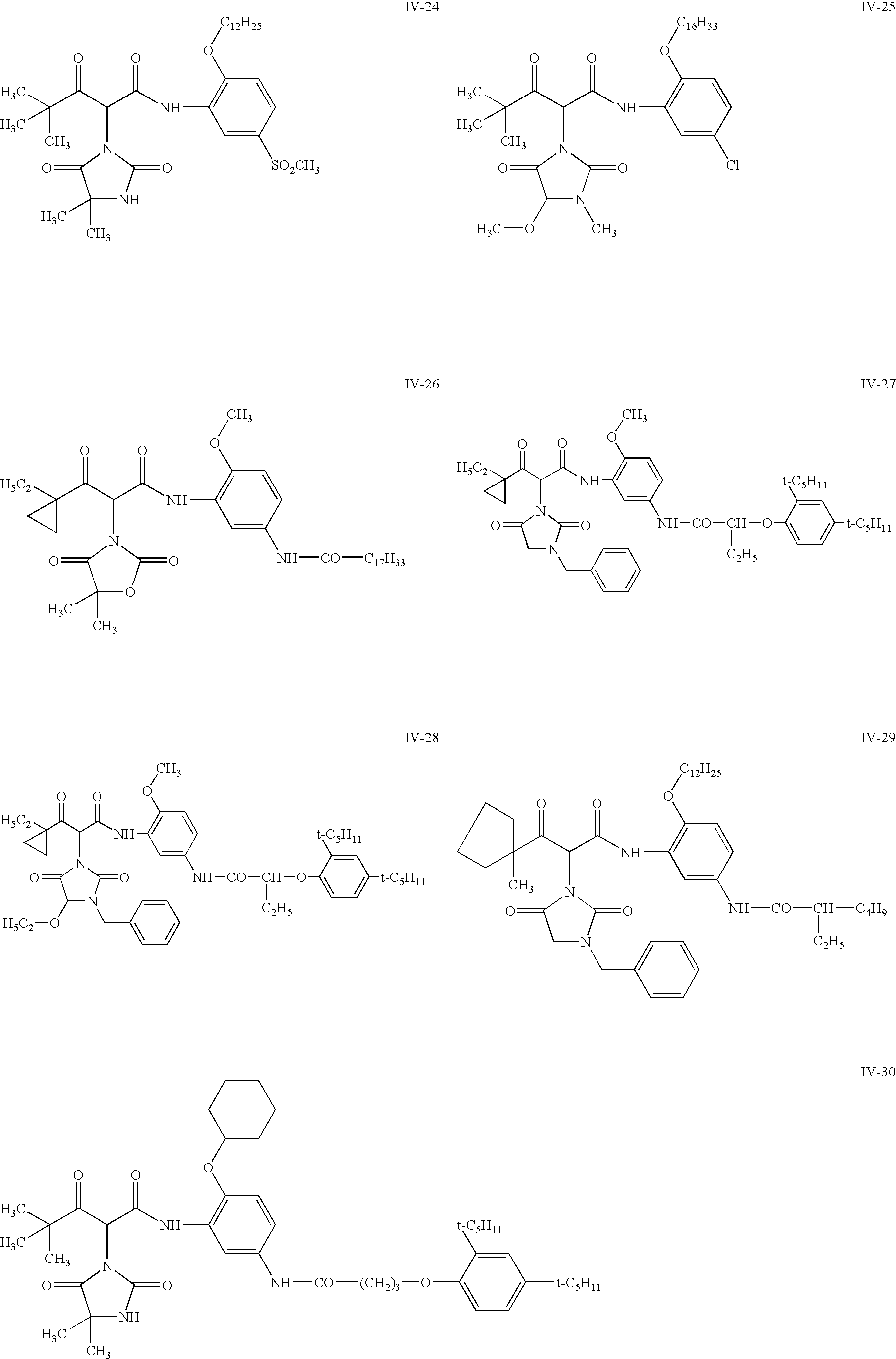

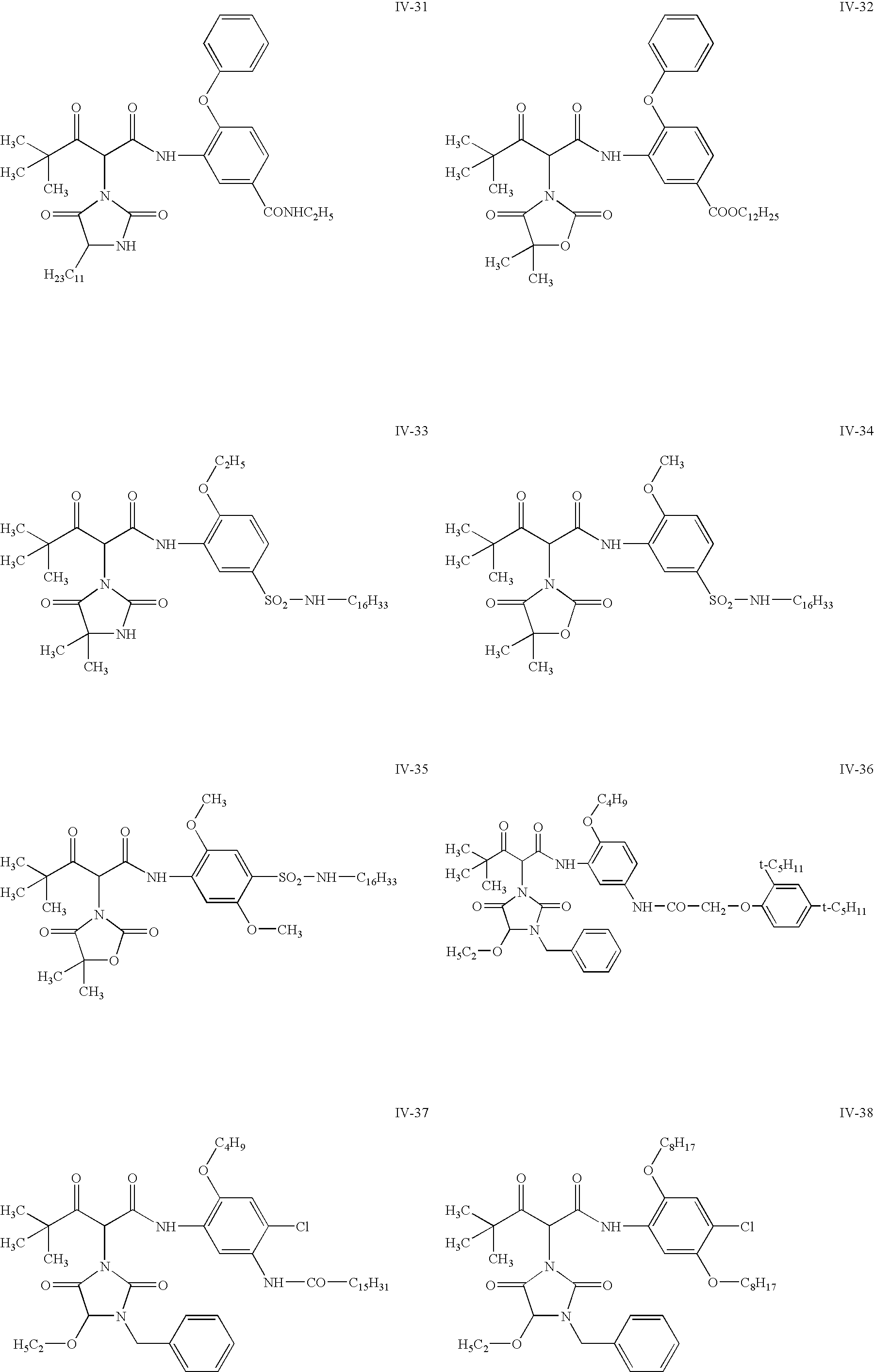

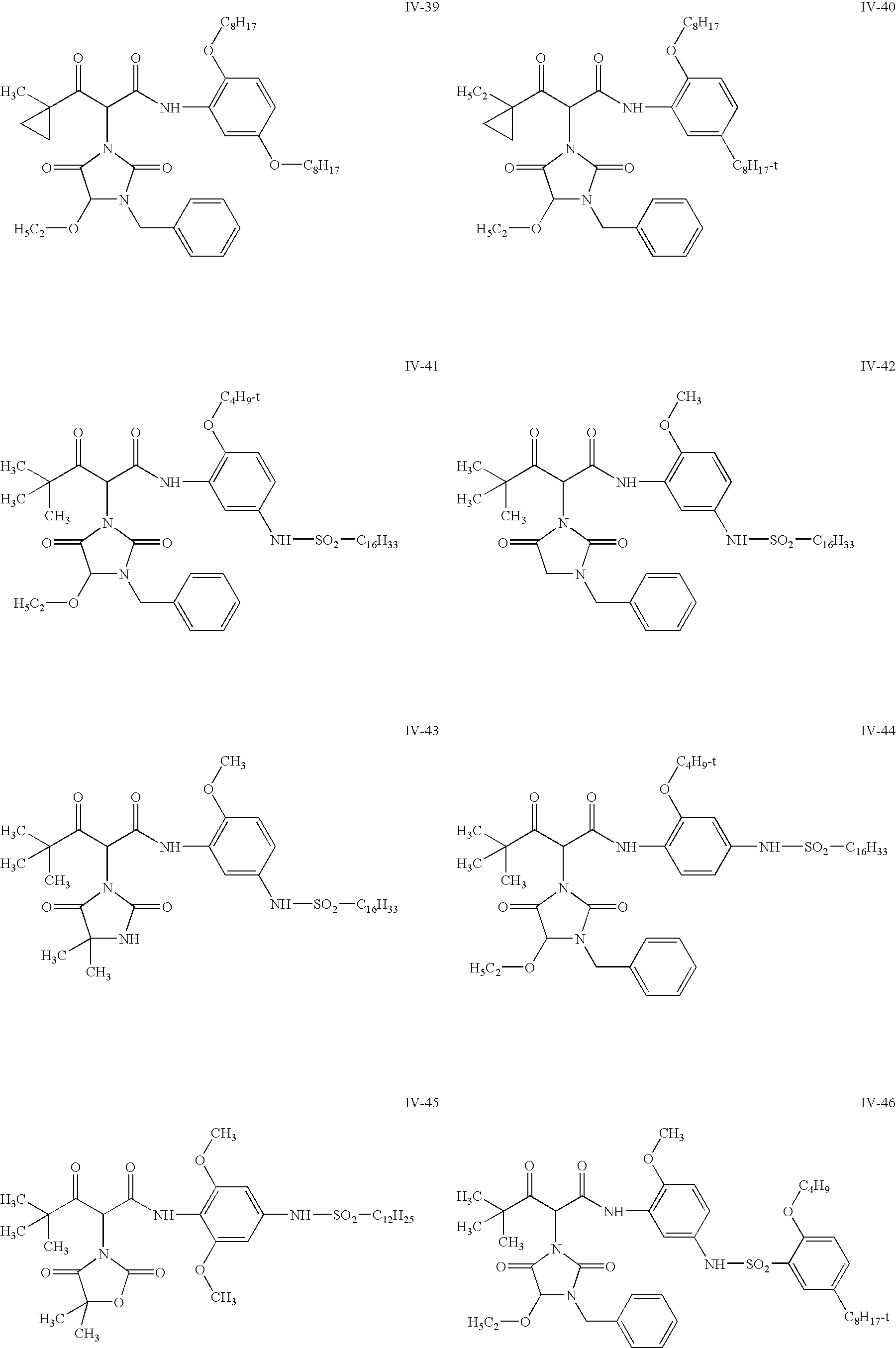

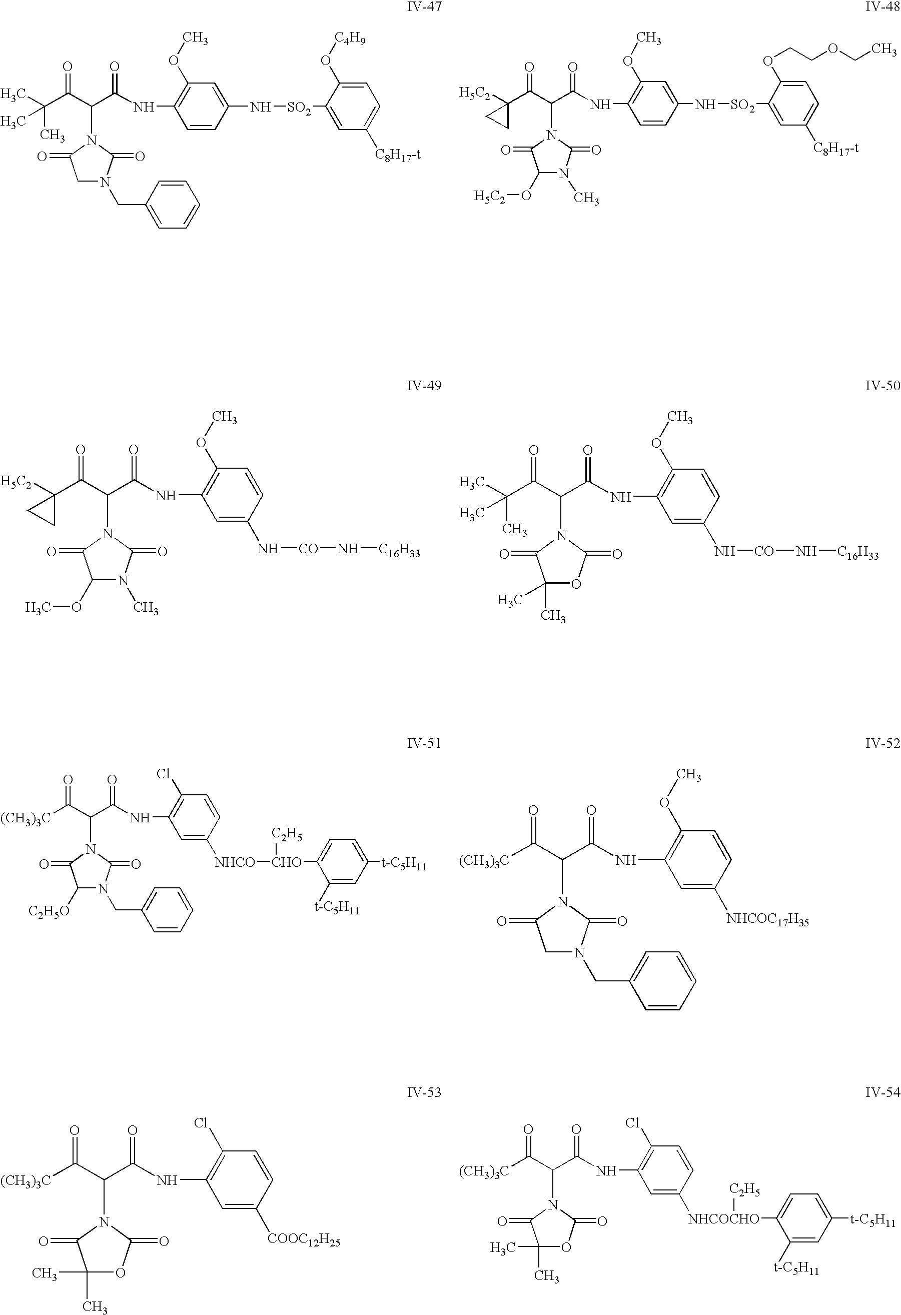

According to a preferred embodiment of the deformable color photographic silver halide material, according to the present invention, the blue-sensitive silver halide emulsion layer contains a blue sensitizer represented by formula (IX):

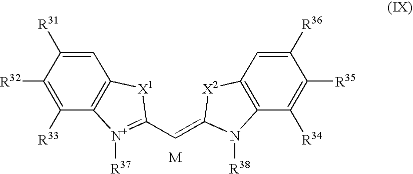

wherein X¹ and X² independently represent S or Se, R³¹ to R³⁶ independently represent hydrogen, halogen or an alkyl-, alkoxy, aryl or hetero-aryl group or R³¹ and R³²; R³² and R³³; R³⁴ and R³⁵; R³⁵ and R³⁶ together represent the atoms necessary to form an anellated benzo-, naphtho- or heterocyclic ring, R³⁷ and R³⁸ independently represent an alkyl-, sulfoalkyl-, carboxyalkyl, —(CH₂)₁SO₂R³⁹SO₂-alkyl, —(CH₂)₁SO₂R³⁹CO-alkyl, —(CH₂)₁COR³⁹SO₂-alkyl or —(CH₂)₁13 COR³⁹CO-alkyl group, R³⁹ represents —N— or —NH—, 1 is a whole number between 1 and 6 and M is an optional counter-ion providing charge compensation.

R³¹ to R³⁶ preferably independently represent hydrogen, F, Cl, Br or alkyl, CF₃, OCH₃ or phenyl groups; or R³¹ and R³²; R³² and R³³; R³⁴ and R³⁵; or R³⁵ and R³⁶ together represent the atoms necessary to form an anellated benzo- or naphtho-ring.

Particularly suitable blue sensitizers include the following compounds, in which “Et” represents Ethyl:

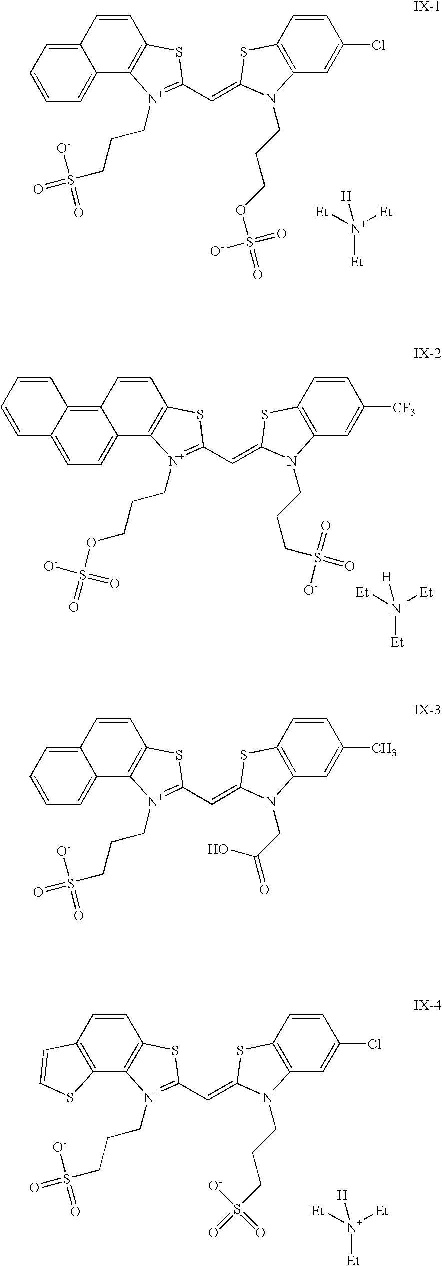

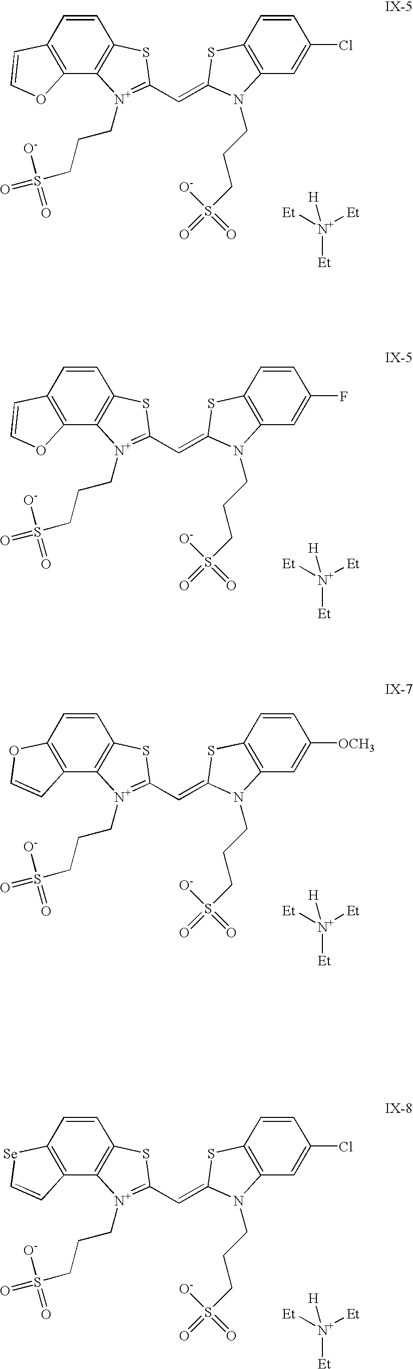

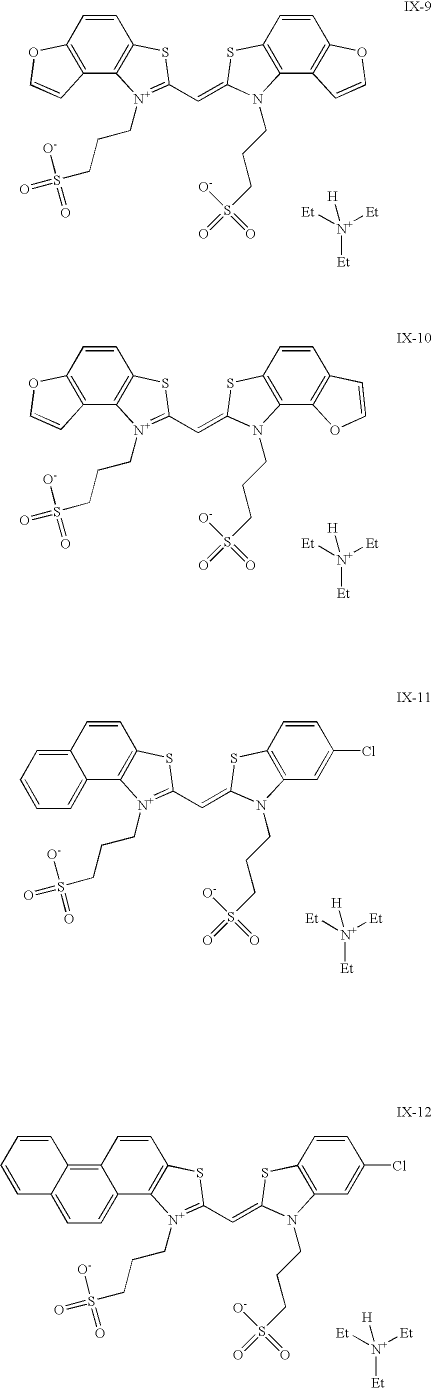

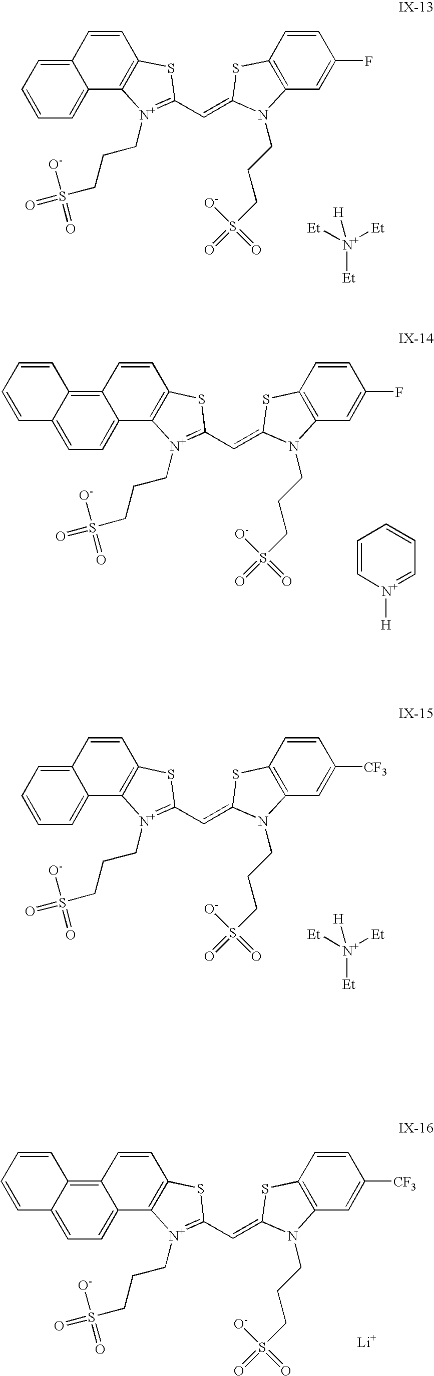

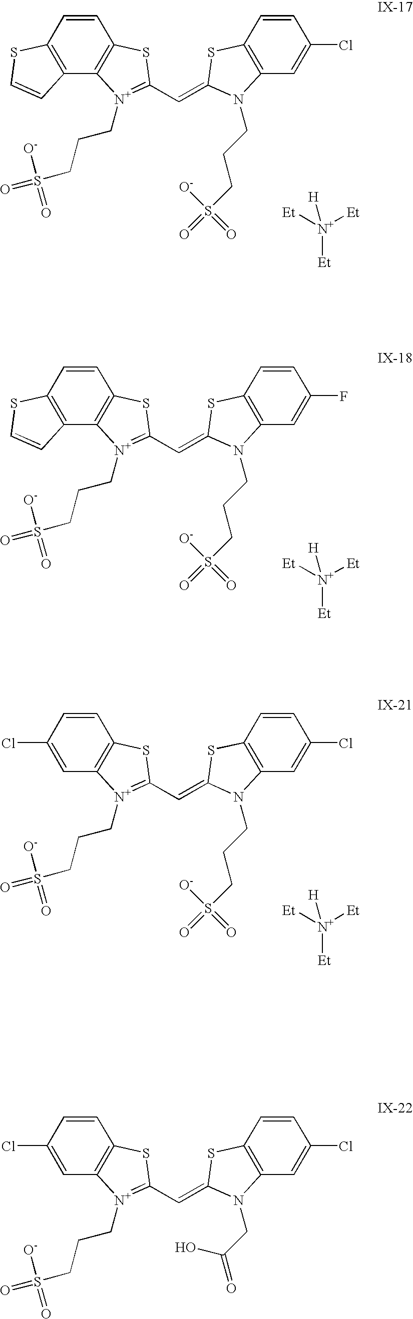

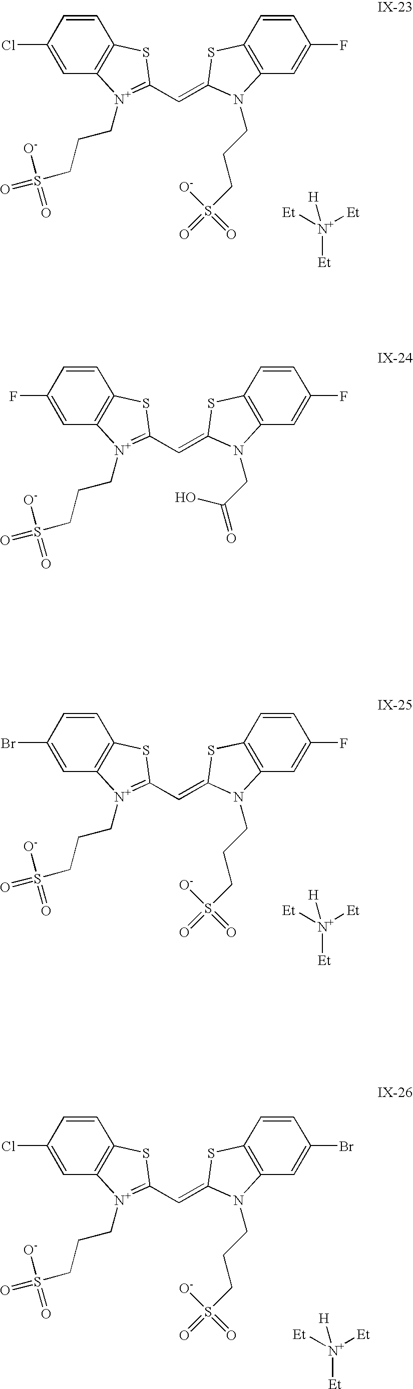

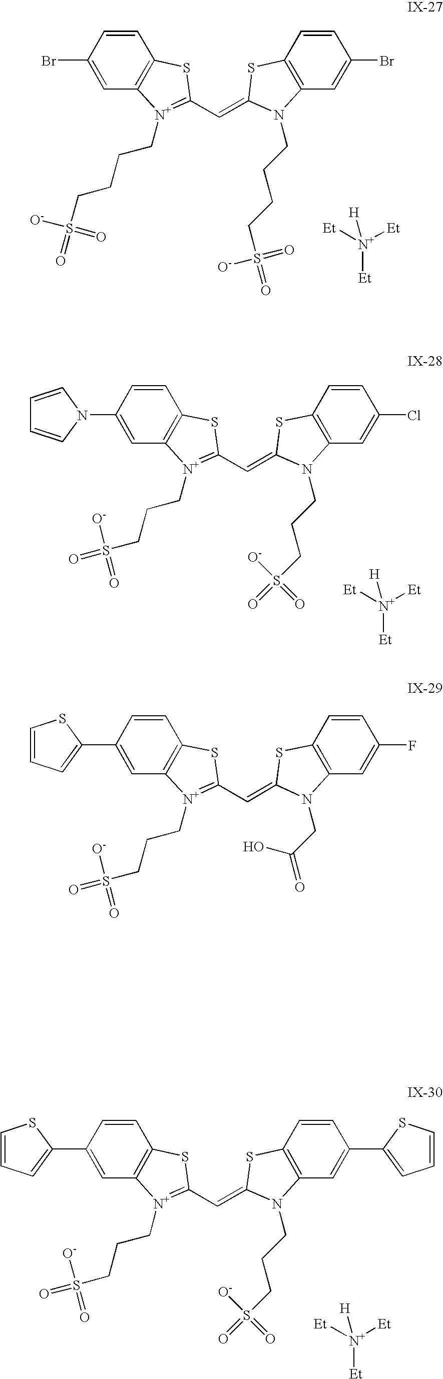

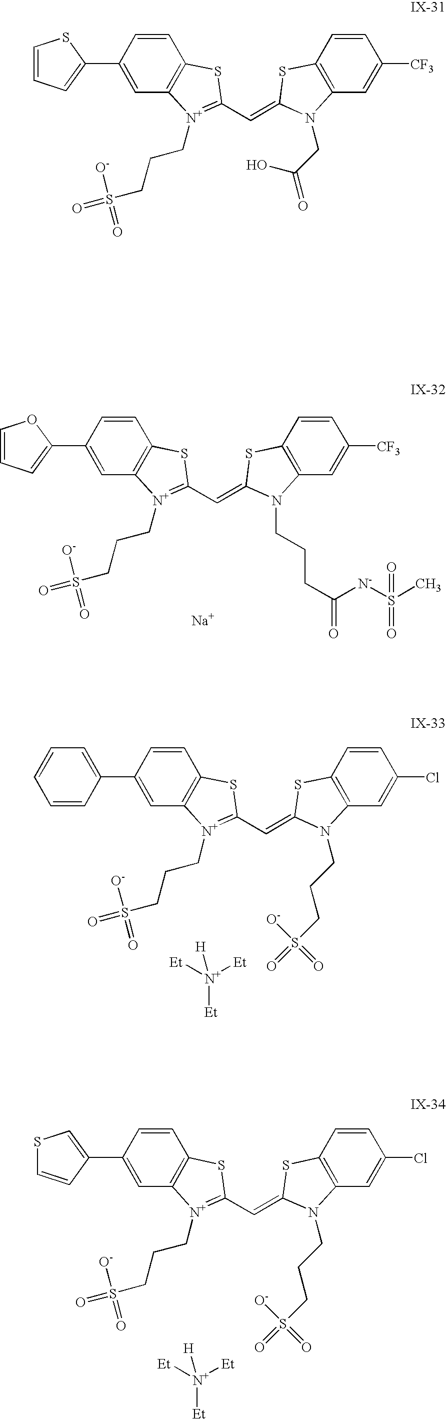

In a preferred embodiment of the present invention, the color photographic material contains at least one blue-sensitive layer comprising a blue sensitizer according to formula (IX) wherein: X¹ and X² represent S, R³⁵ represents a trifluormethyl group or a halogen atom, in particular a chlorine atom, R³² and R³³ together represent the atoms necessary to form an anellated benzo-, naphtho- or heterocyclic ring, particularly an anellated benzo-ring and R³⁷ and R³⁸ independently represent sulfoalkyl-, carboxyalkyl, —(CH₂)₁SO₂R³⁹SO₂-alkyl, —(CH₂)₁SO₂R³⁹CO-alkyl-, —(CH₂)₁COR³⁹SO₂-alkyl, —(CH₂)₁-COR³⁹CO-alkyl, particularly sulfoalkyl groups.

Suitable red sensitizers include compounds according to formula (X) and (XI):

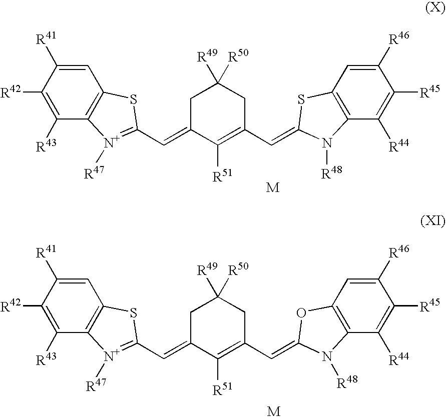

wherein R⁴¹ to R⁴⁶ independently represent hydrogen, halogen or an alkyl-, alkoxy, aryl or hetero-aryl group; or R⁴¹ and R⁴²; R⁴² and R⁴³; R⁴⁴ and R⁴⁵;or R⁴⁵ and R⁴⁶ together represent the atoms necessary to form an anellated benzo-, naphtho- or heterocyclic ring, R⁴⁷ and R⁴⁸ independently represent an alkyl-, sulfoalkyl-, carboxyalkyl, —(CH₂)₁SO₂YSO₂-alkyl, —(CH₂)₁SO₂YCO-alkyl, —(CH₂)₁COYSO₂-alkyl or —(CH₂)₁—COYCO-alkyl group, Y represents —N— or —NH—, R⁴⁹ and R⁵⁰ independently represent a hydrogen atom or an alkyl- or an aryl group, R⁵¹ represents a hydrogen atom, a halogen atom or an alkyl group and M represents an optional counter-ion providing charge compensation.

R⁴¹ to R⁴⁶ preferably independently represent hydrogen, F, Cl, Br or alkyl, CF₃, OCH₃ or phenyl groups; or R⁴¹ and R⁴²; R⁴² and R⁴³; R⁴⁴ and R⁴⁵;or R⁴⁵ and R⁴⁶ together represent the atoms necessary to form an anellated benzo- or naphtho-ring.

Examples of red sensitizers are given below, wherein “Et” represents Ethyl:

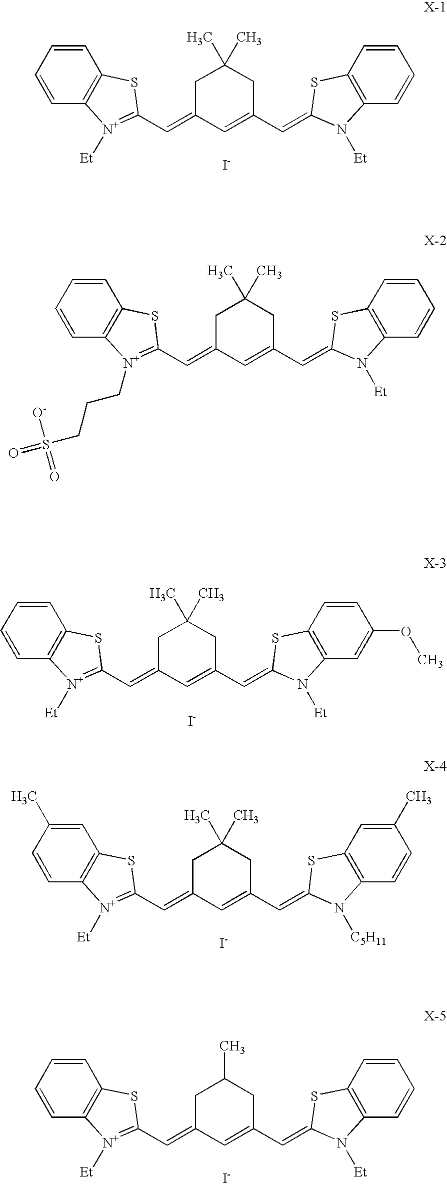

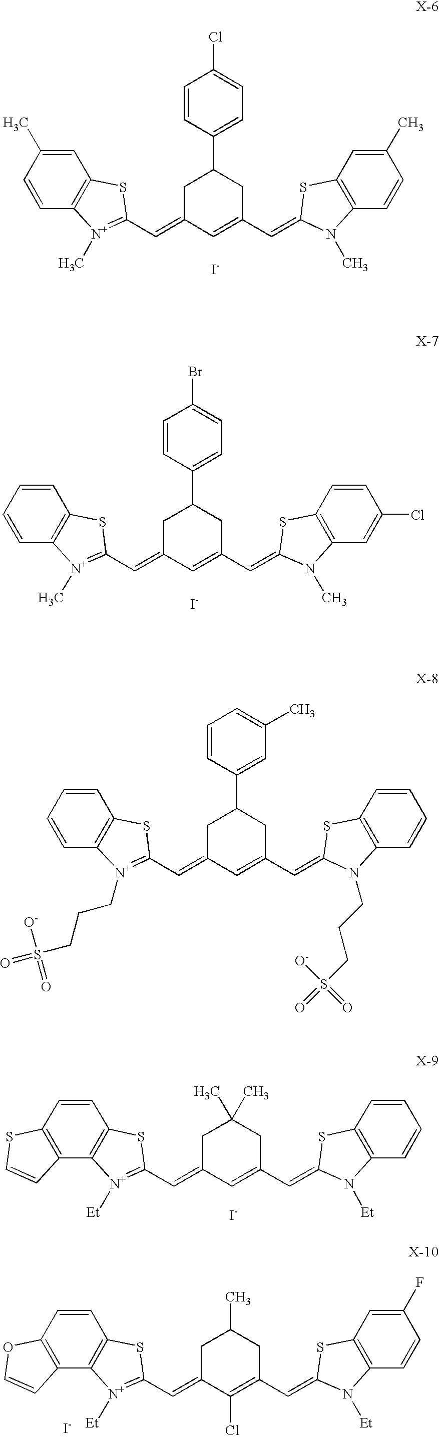

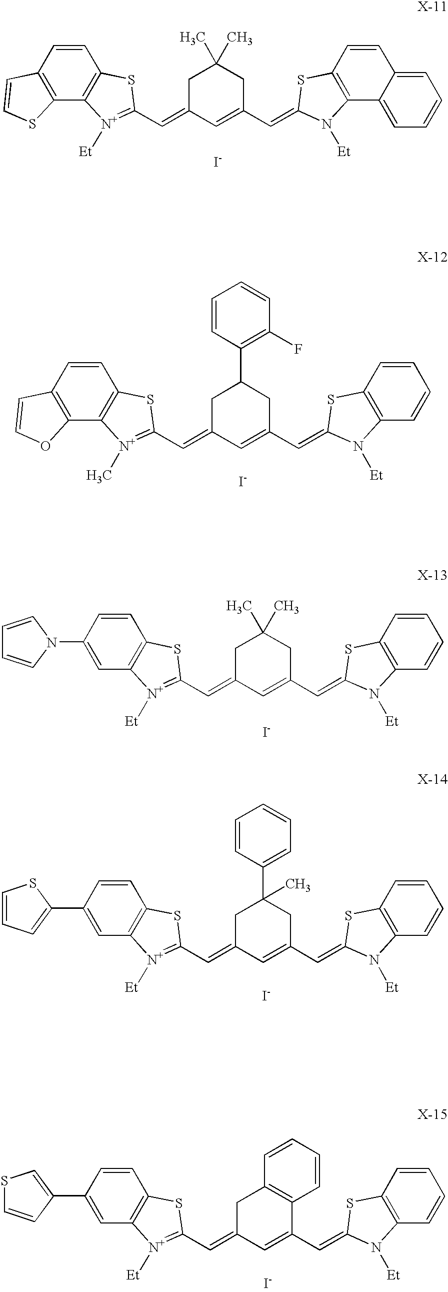

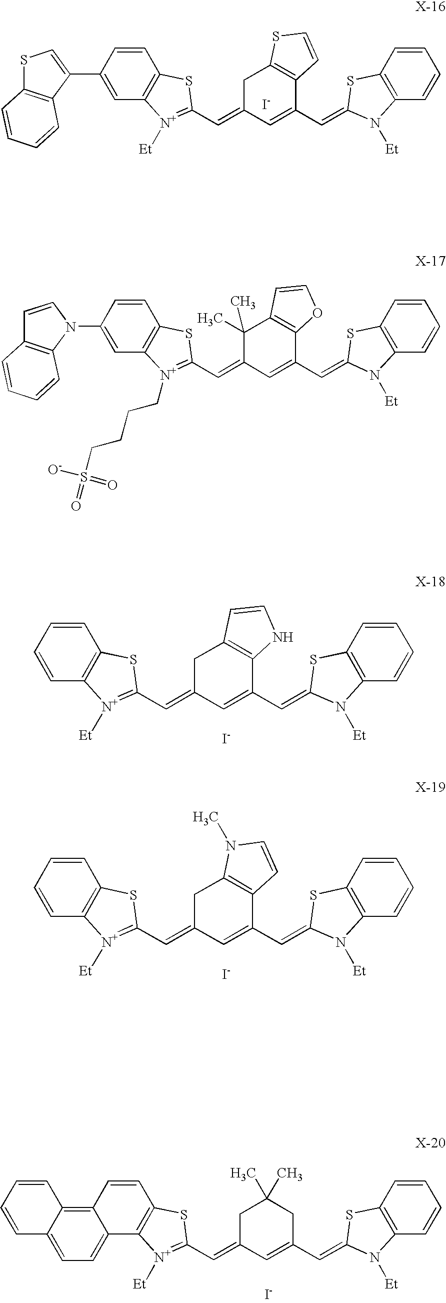

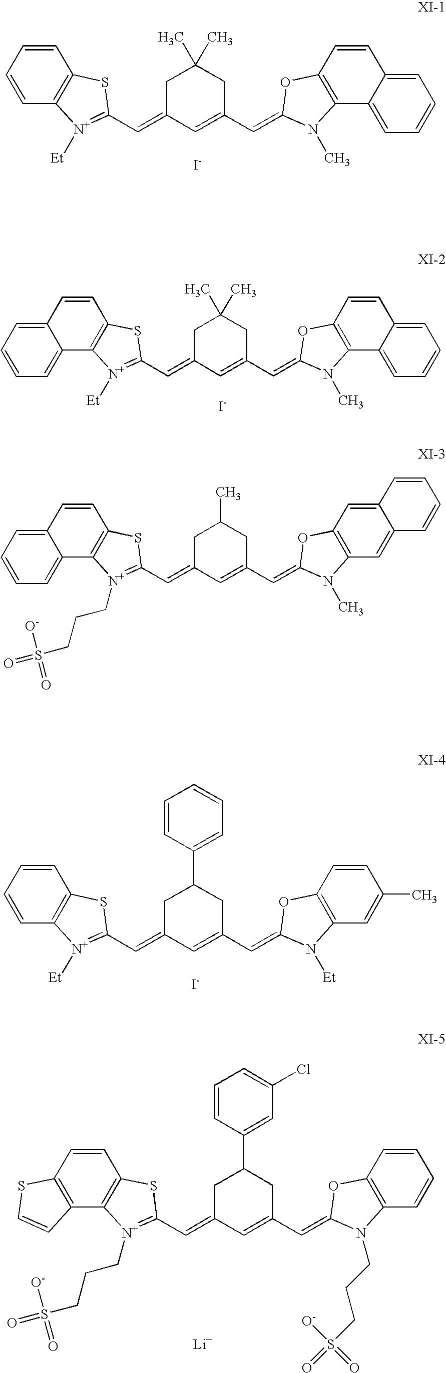

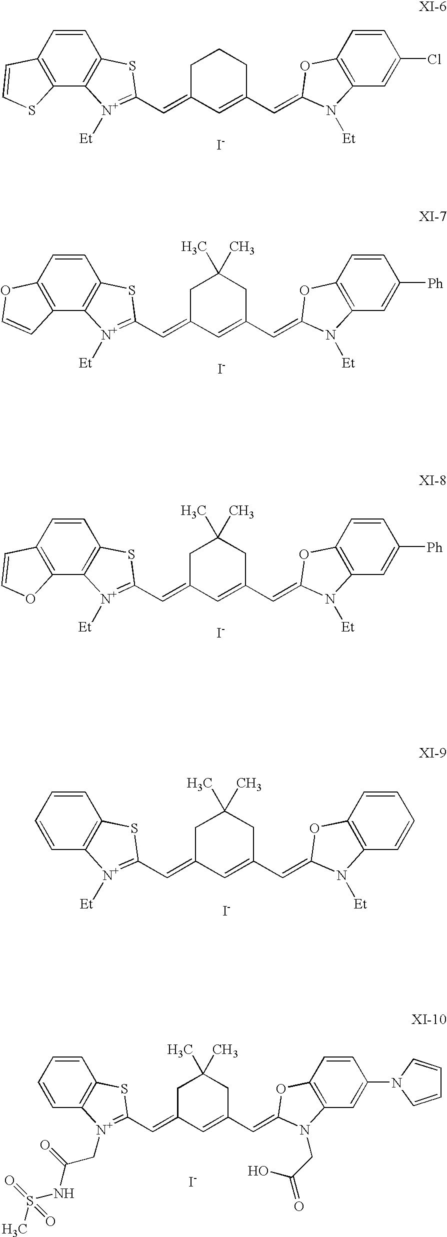

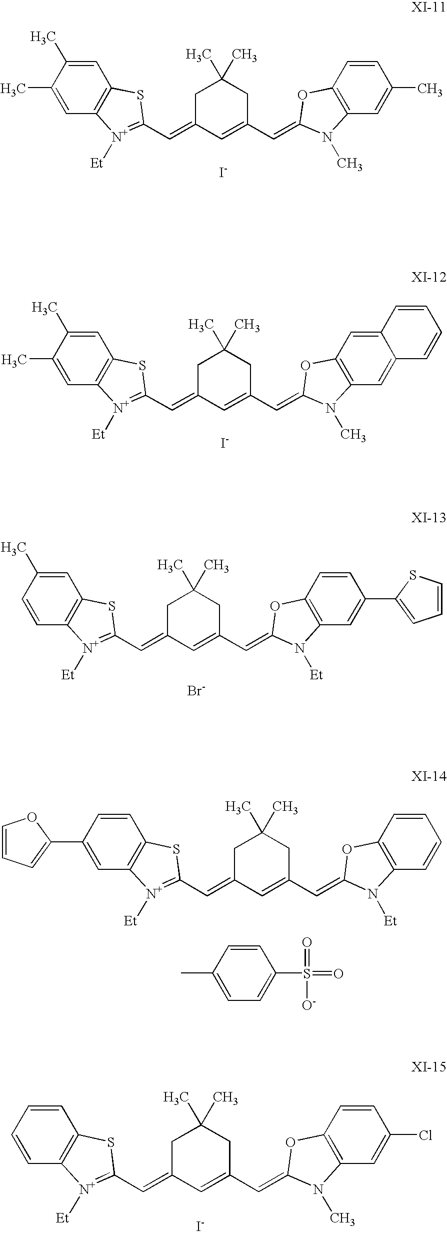

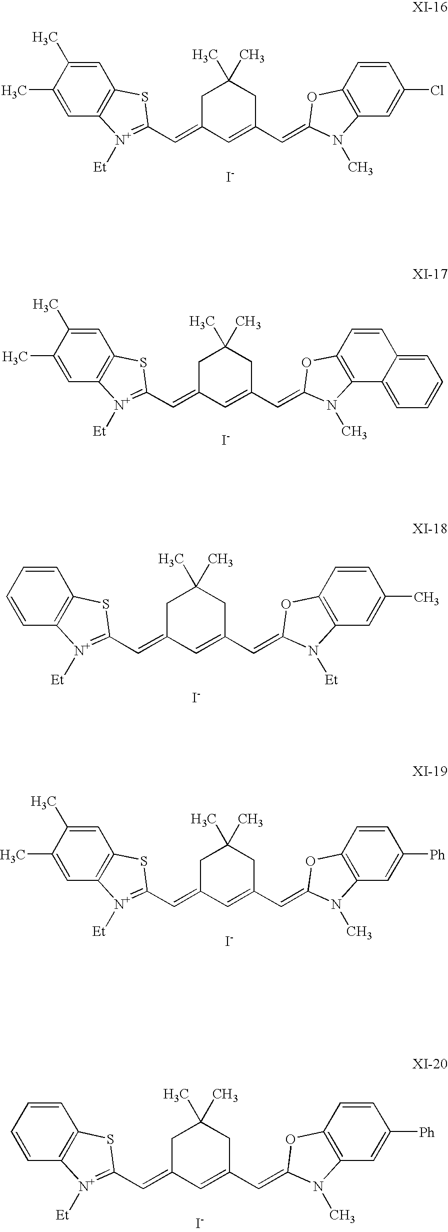

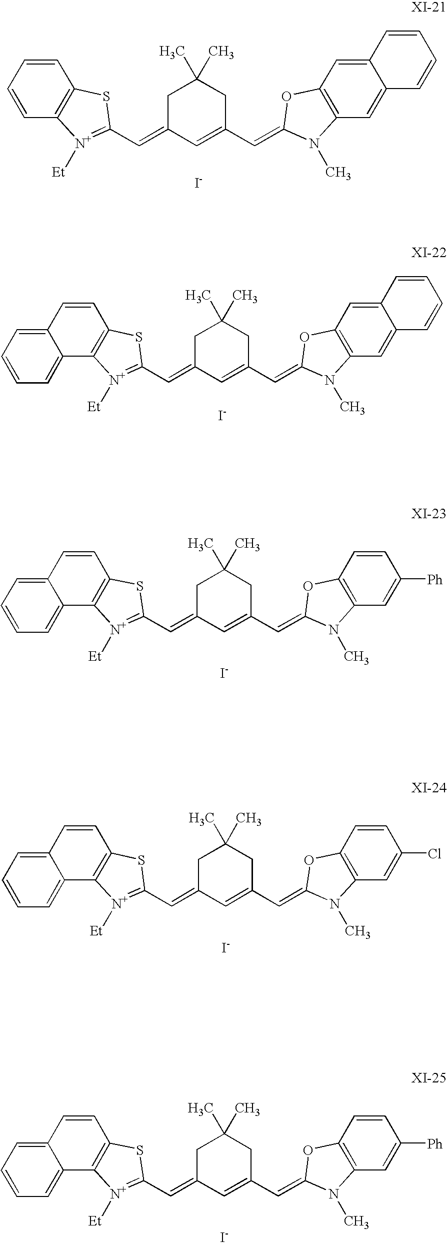

In a further preferred embodiment of the deformable color photographic silver halide material, according to the present invention, the deformable color photographic material contains a layer containing at least one compound represented by formula (XII)

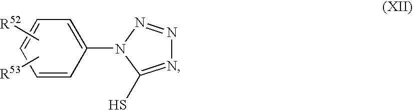

in which R represents H, CH₃ or OCH₃; R ⁵³ represents H, OH, CH₃, OCH₃, NHCO—R⁵, COOR , SO₂NH₂, NHCONH₂ or NHCONH—CH₃; and R represents a C₁-C₄-alkyl group. Compounds according to formula (XII) are preferably present in a light-sensitive layer in a quantity of 50 to 5000 mg per kg Ag, particularly preferably in a quantity of 200 to 2000 mg per kg Ag.

Preferred compounds according to formula (XII) are given below:

| | R⁵² | R⁵³ |
|---|---|---|
| XII-1 | H | H |
| XII-2 | H | o-OCH₃ |
| XII-3 | H | m-OCH₃ |
| XII-4 | H | p-OCH₃ |
| XII-5 | H | o-OH |
| XII-6 | H | m-OH |
| XII-7 | H | p-OH |
| XII-8 | H | m-NHCOCH₃ |
| XII-9 | H | p-COOC₂H₅ |
| XII-10 | H | p-COOH |
| XII-11 | H | m-NHCONH₂ |
| XII-12 | H | p-SO₂NH₂ |
| XII-13 | o-OCH₃ | p-OCH₃ |
| XII-14 | H | m-NHCONHCH₃ |

In a particularly preferred embodiment of the present invention, the color photographic material contains a compound according to formula (XII) in a blue-sensitive silver halide emulsion layer.

In a preferred embodiment of the present invention, the color photographic material contains at least one layer containing a compound according to formula (XIII):

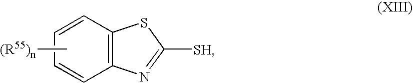

in which R⁵⁵ represents a substituent and n is 1, 2 or 3. Preferably R⁵⁵ represents a polar group, in particular a sulfo group, a sulfonate group, or a substituted or unsubstituted sulfonamido group. The sulfonamido group can be bonded through the S- or the N-aton of the group.

Compounds according to formula (XIII) are preferably present in a red-sensitive silver halide emulsion layer in a quantity of 100 to 5000 mg per kg Ag, particularly preferably in a quantity of 500 to 3000 mg per kg Ag.

Stabilizers according to formula (XIII) are particularly preferred in which R⁵⁵ represents

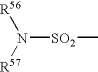

and; R⁵⁶ and R⁵⁷ independently represent H, Cl or C₁-C₄-alkyl, phenyl or chlorophenyl groups.

Particularly preferred compounds according to formula (XIII) include:

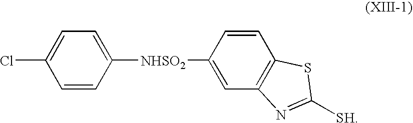

In a particularly preferred embodiment of the present invention, the red-sensitive layer contains at least one compound according to formula (XII) and at least one compound according to formula (XIII).

The main ingredients of photographic emulsion layers are binders, silver halide crystals and color couplers. Details over suitable binders are to be found in Research Disclosure 37254, part 2 (1995) page 286, herein incorporated by reference.

The mostly hydrophobic color couplers, as well as other hydrophobic ingredients in the layer, are usually dissolved or dispersed in high boiling point organic solvents. These solutions or dispersions are then emulsified in an aqueous binder solution (usually gelatin) and remain in the layers after drying as fine droplets (0.05 to 0.8 μm in diameter).

Suitable high boiling point organic solvents, methods for incorporation in the layers of a photographic material and other methods to incorporate chemical compounds in photographic layers are to be found in Research Disclosure 37254, part 6 (1995) page 292, herein incorporated by reference.

The light-insensitive layers generally coated between the light-sensitive layers with different spectral sensitivities can contain ingredients, which hinder undesirable diffusion of developer oxidation products from one light-sensitive layer to another such layer with different spectral sensitization.

Suitable compounds (white couplers, scavengers for developer oxidation products (also called DOP scavengers, Dox scavengers, interlayer scavengers or just scavengers) are to be found in Research Disclosure 37254, part 7 (1995) page 292 and in Research Disclosure 37038, part III, page 84 herein incorporated by reference.

The color photographic material may further contain UV-light absorbing compounds, brighteners, spacing agents, filter dyes, formaldehyde captors, anti-fading agents, antioxidants, Dₘᵢₙ-dyes, additives to improve the dye, coupler and white image area stability, additives to reduce color fog, plasticizers (latices), biocides and polyvinylpyrrolidone. Such additives and other additives can be contained in the emulsion and interlayers, but can also be contained in additional layers between the support and emulsion layers and/or on the non-emulsion layer-bearing side of the support. Suitable compounds are to be found in Research Disclosure 37254, part 8 (1995) page 292 and in Research Disclosure 37038, parts IV, V, VI, VII, X, XI and XIII (1995), from page 84 herein incorporated by reference.

The layers of the color photographic material are usually hardened i.e. the binders used, preferably gelatin, is crosslinked by a suitable chemical process. Immediate or fast hardeners are preferably employed. Suitable immediate and fast hardeners are to be found in Research Disclosure 37254, part 9 (1995), page 294 and in Research Disclosure 37038, part XII (1995), page 86, herein incorporated by reference.

The outermost layers of the photographic material and in particular the outermost layer on the image side can be embossed and/or coloured and/or printed with any kind of design, image or text.

### Industrial Application

The process for producing a deformed image, according to the present invention, can be used to apply any kind of representations like images, designs, patterns, letters and so forth to a wide variety of work pieces including pieces of furniture.

The invention is illustrated hereinafter by way of comparative and invention examples. The percentages and ratios given in these examples are by weight unless otherwise indicated.

The following compounds were used in the EXAMPLES:

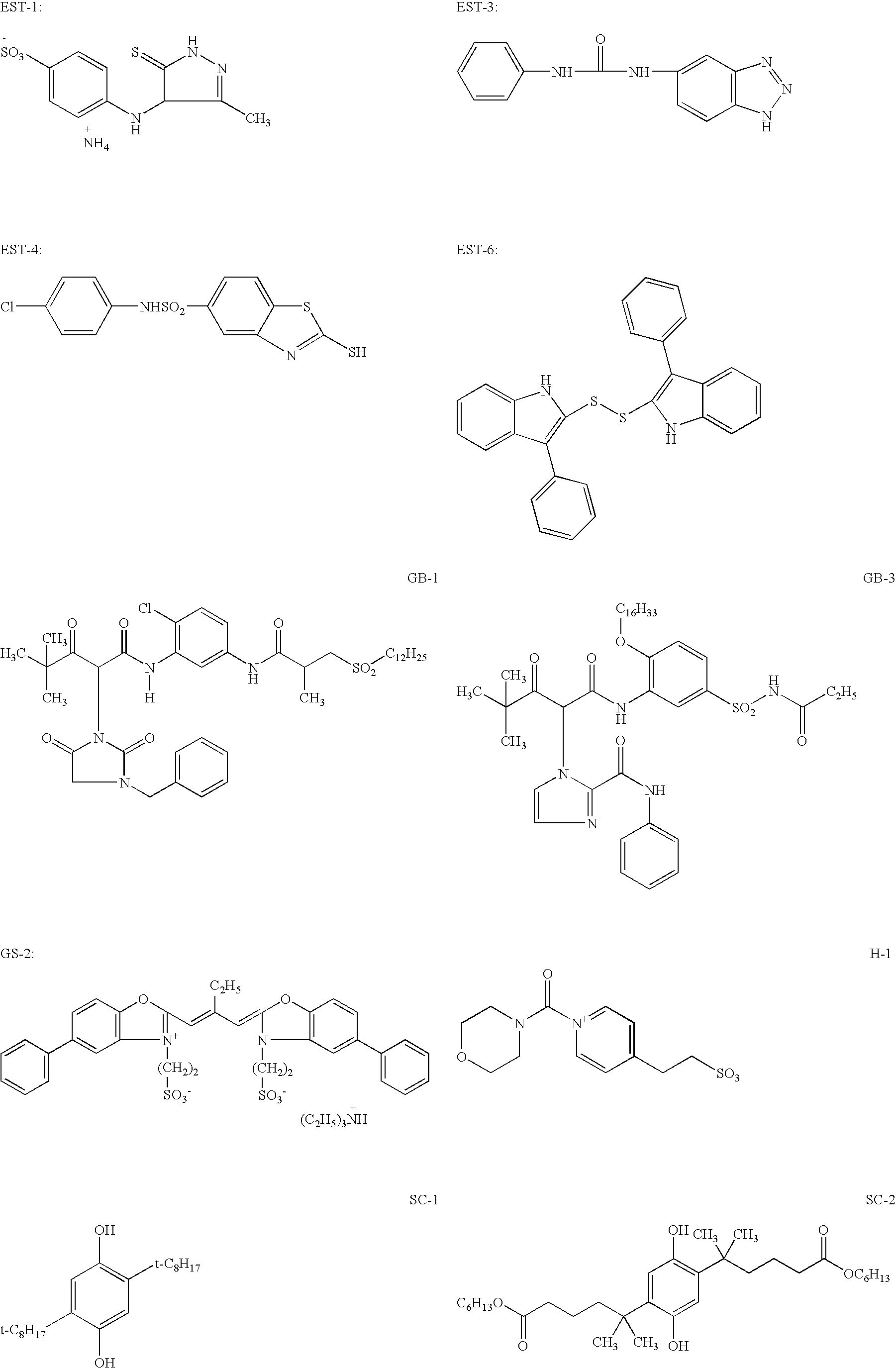

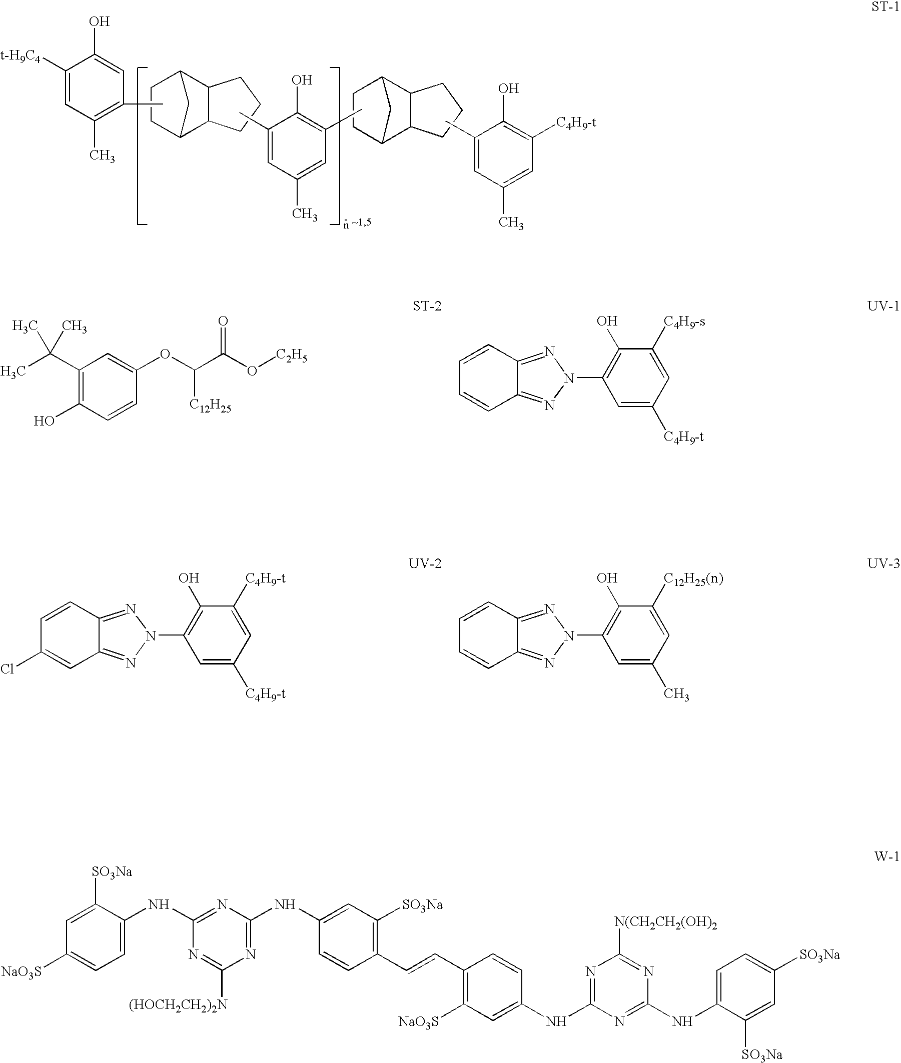

### Preparation of Silver Halide Emulsions

Lippmann Emulsion (EmM1)

The following solutions were prepared:

| | | | |
|---|---|---|---|
| Solution 01 | deionized water | 1100 | g |
| | gelatin | 140 | g |
| | n-decanol | 1 | g |
| | NaCl | 4 | g |
| Solution 02 | deionized water | 1860 | g |
| | NaCl | 360 | g |
| Solution 03 | deionized water | 1800 | g |
| | AgNO₃ | 1000 | g |

Solutions 02 and 03 at 40° C. were simultaneously added at a constant rate to Solution 01 in a precipitation vessel at a pAg of 7.7 and a pH of 5.3 with vigorous stirring over a period of 30 minutes. During the precipitation the pAg-value was maintained by adding a sodium chloride solution and the pH maintained by adding dilute sulphuric acid to the precipitation vessel. A silver chloride emulsion was obtained with an average silver chloride grain size of 0.09 μm. The weight ratio of gelatin to silver nitrate was 0.14. The emulsion was then subjected to ultrafiltration at 50° C. and redispersed with sufficient gelatin and deionized water to yield a dispersion containing 200 g of silver chloride per kg dispersion, a weight ratio of gelatin to silver nitrate (equivalent to AgX present) of 0.3 and an average silver chloride grain size of 0.13 μm.

Lippmann Emulsion (EmM2)

Lippmann emulsion EmM2 was prepared as described for EmM1 except that Solution 04 was used instead of Solution 02.

| | | | |
|---|---|---|---|
| Solution 04 | deionized water | 1860 | g |
| | NaCl | 360 | g |
| | K₂IrCl₆ | 200 | μg |

The emulsion obtained contained 90 mol % silver chloride, 10 mol % silver bromide and 70×10⁻⁹ mol Ir⁴⁺ per mol silver chloride.

Lippmann Emulsion (EmM3)

Lippmann emulsion EmM3 was prepared as described for EmM1 except that Solution 05 was used instead of Solution 02.

| | | | |
|---|---|---|---|
| Solution 05 | deionized water | 1860 | g |
| | NaCl | 360 | g |
| | K₂IrCl₆ | 5680 | μg |

The emulsion obtained contained 2000×10⁻⁹ mol Ir per mol silver chloride.

Blue-Sensitive Emulsions EmB1-EmB3

EmB1

The following solutions were prepared:

| | | | |
|---|---|---|---|
| Solution 11 | deionized water | 1100 | g |
| | gelatin | 136 | g |
| | n-decanol | 1 | g |
| | NaCl | 4 | g |
| | EmM1 | 36 | g |
| Solution 12 | deionized water | 1860 | g |
| | NaCl | 360 | g |
| | K₂IrCl₆ | 14.2 | μg |
| Solution 13 | deionized water | 1800 | g |
| | AgNO₃ | 1000 | g |

Solutions 12 and 13 at 50° C. were simultaneously added to Solution 11 in a precipitation vessel at a pAg of 7.7 with vigorous stirring over a period of 150 minutes. During the precipitation the pAg-value was maintained by adding a sodium chloride solution and a pH of 5.3 was maintained by adding dilute sulphuric acid to the precipitation vessel. The addition rate of both Solutions 12 and 13 was so regulated that in the first 100 minutes it increased linearly from 2 mL/min to 16 mL/min and during the final 50 minutes was held constant at 20 mL/min. A silver chloride emulsion was thereby obtained with an average silver chloride grain size of 0.85 μm. The weight ratio of gelatin to silver nitrate (equivalent to AgX) was 0.14. The emulsion was then subjected to ultrafiltration at 50° C. and redispersed with sufficient gelatin and deionized water to yield a dispersion containing 200 g of silver chloride per kg dispersion and a weight ratio of gelatin to silver nitrate (equivalent to AgX present) of 0.56. The emulsion thereby obtained contained 5×10⁻⁹ mol Ir⁴⁺ per mole of silver chloride.

The emulsion first was prestabilized with 0.01 mmol of compound EST-6 and then was chemically ripened at a pH of 5.3 with 0.13×10⁻⁶ mol ammonium tetrachloroaurate and 5.4×10⁻⁶ mol sodium thiosulphate per mole of silver chloride for 180 minutes at a temperature of 47° C. After chemical ripening the following ingredients were added per mole of silver chloride at 40° C.: 0.3 mmol of the spectral sensitizing compound (IX-1), 0.5 mmol of the stabilizing compound XII-8, 0.5 mmol of the stabilizing compound EST-1 and finally 0.6 mmol of potassium bromide.

EmB2

The precipitation, desalting and redispersion were carried out as described for EmB1, except that 28.4 μg K₂IrCl₆ was added to solution 12. The emulsion thereby obtained contained 10×10⁻⁹ mol Ir⁴⁺ per mole silver chloride.

The emulsion first was prestabilized with 0.01 mmol of compound EST-6 and then was chemically ripened at a pH of 5.3 with 0.13×10⁻⁶ mol ammonium tetrachloroaurateand 5.4×10⁻⁶ mol sodium thiosulphate per mole of silver chloride for 180 minutes at a temperature of 47° C. After chemical ripening the following ingredients were added per mole of silver chloride at 40° C.: 0.3 mmol of the spectral sensitizing compound (IX-1), 0.5 mmol of the stabilizing compound XII-8, 0.5 mmol of the stabilizing compound EST-1 and finally 0.6 mmol of potassium bromide.

EmB3

The emulsion is prepared by recrystallization of the Lippmann emulsion EmM2 onto the separate preprecipitate emulsion (nucleus emulsion) EmV1, which was prepared as follows:

Preparation of the Preprecipitate Emulsion EmV1

The precipitation, desalting and redispersion were carried out as described for EmB1, except that the amount of EmM1 added to solution 11 was increased to 40 g. A silver chloride emulsion was thereby obtained with an average silver chloride grain size of 0.82 μm.

Preparation of EmB3

1.5 kg of EmV1 (representing 300 g AgNO₃) melted at 40° C. in a precipitation vessel while stirring. In a separate vessel 0.25 kg of Lippmann emulsion EmM2 (representing 50 g AgNO₃) was melted at 40° C. while stirring. Under vigorous stirring, 25 ml of a 20% by weight NaCl solution was added to EmV1. After a digestion of 5 minutes EmM2 is added to EmV1 within 50 minutes at a constant rate. After a digestion of 10 minutes the emulsion was then redispersed with sufficient gelatin and deionized water to yield a weight ratio of gelatin to silver nitrate (equivalent to AgX present) of 0.56. A silver chloride emulsion was thereby obtained with an average silver chloride grain size of 0.85 μm. The emulsion thereby obtained contained 10×10⁻⁹ mol Ir⁴⁺ per mole of silver chloride.

The emulsion first was prestabilized with 0.01 mmol of compound EST-6 and then was chemically ripened at a pH of 5.3 with 0.13×10⁻⁶ mol ammonium tetrachloroaurate and 5.4×10⁻⁶ mol sodium thiosulphate per mole of silver chloride for 180 minutes at a temperature of 47° C. After chemical ripening the following ingredients were added per mole of silver chloride at 40° C.: 0.3 mmol of the spectral sensitizing compound (IX-1), 0.5 mmol of the stabilizing compound XII-8, 0.5 mmol of the stabilizing compound EST-1 and finally 0.6 mmol of potassium bromide.

Green-Sensitive Emulsions EmG1-EmG3

EmG1

The following solutions were prepared:

| | | | |
|---|---|---|---|
| Solution 21 | deionized water | 1100 | g |
| | gelatin | 136 | g |
| | n-decanol | 1 | g |
| | NaCl | 4 | g |
| | EmM1 | 195 | g |
| Solution 22 | deionized water | 1860 | g |
| | NaCl | 360 | g |
| | K₂IrCl₆ | 14.2 | μg |
| | RhCl₃ · 3H₂O | 3.8 | μg |
| Solution 23 | deionized water | 1800 | g |
| | AgNO₃ | 1000 | g |

Solutions 22 and 23 at 48° C. were simultaneously added to Solution 21 in a precipitation vessel at a pAg of 7.7 with intensive stirring over a period of 75 minutes. During the precipitation the pAg-value was maintained by adding a sodium chloride solution and a pH-value of 5.3 was maintained by adding dilute sulphuric acid to the precipitation vessel. The addition rate of both solutions 22 and 23 was so regulated that in the first 50 minutes it increased linearly from 4 mL/min to 36mL/min and during the final 25 minutes was held constant at 40 mL/min. A silver chloride emulsion was thereby lo obtained with an average silver chloride grain size of 0.50 μm. The weight ratio of gelatin to silver nitrate (equivalent to AgX) was 0.14. The emulsion was then subjected to ultrafiltration at 50° C., washed and redispersed with sufficient gelatin and deionized water to yield a dispersion containing 200 g of silver chloride per kg dispersion, 5×10⁻⁹ mol Ir⁴⁺ and 2.5×10⁻⁹ mol Rh³⁺ per mol silver chloride and a weight ratio of gelatin to silver nitrate (equivalent to AgX present) of 0.56.

The emulsion was then chemically ripened at a pH of 6.0 with 0.82×10⁻⁶ mol ammonium tetrachloroaurate and 2.74×10⁻⁶ mol sodium thiosulphate per mole of silver chloride for 240 minutes at a temperature of 45° C. After chemical ripening the following ingredients were added per mole AgCl at 40° C.: 0,6 mmol of the green sensitizing compound (GS-2), 2.4 mmol of the stabilizing compound EST-3, 1.2 mmol of the stabilizing compound (EST-1), 0,6 mmol of the stabilizing compound (XII-1) and finally 3 mmol of potassium bromide.

EmG2

The precipitation, desalting and redispersion were carried out as described for EmG1 except that the amount of K₂IrCl₆ in Solution 22 was increased from 14,2 μg to 284 μg. The emulsion thereby obtained contained 100×10⁻⁹ mol Ir⁴⁺ per mole silver chloride.

The emulsion was then chemically ripened at a pH of 6.0 with 0.574×10⁻⁶ mol ammonium tetrachloroaurate and 1,92×10⁻⁶ mol sodium thiosulphate per mole of silver chloride for 240 minutes at a temperature of 45° C. After chemical ripening the following ingredients were added per mole AgCl at 40° C.: 0,6 mmol of the green sensitizing compound (GS-2), 2.4 mmol of the stabilizing compound EST-3, 1.2 mmol of the stabilizing compound (EST-1), 0,6 mmol of the stabilizing compound (XII-1) and finally 3 mmol of potassium bromide.

EmG3

The emulsion is prepared by recrystallization of the Lippmann emulsion EmM3 onto the separate preprecipitate emulsion (nucleus emulsion) EmV2, which was prepared as follows:

Preparation of the Preprecipitate Emulsion EmV2

The precipitation, desalting and redispersion were carried out as described for EmG1, except that the amount of EmM1 added to solution 21 was increased to 250 g. A silver chloride emulsion was thereby obtained with an average silver chloride grain size of 0.46 μm.

Preparation of EmG3

1.5 kg of EmV2 (representing 300 g AgNO₃) melted at 40° C. in a precipitation vessel while stirring. In a separate vessel 0.5 kg of Lippmann emulsion EmM3 (representing 100 g AgNO₃) was melted at 50° C. while stirring. Under vigorous stirring, 25 ml of a 20% by weight NaCl solution was added to EmV2. After a digestion of 5minutes EmM3 is added to EmV2 within 80 minutes at a constant rate. After a digestion of 10 minutes the emulsion was then redispersed with sufficient gelatin and deionized water to yield a weight ratio of gelatin to silver nitrate (equivalent to AgX present) of 0.56. A silver chloride emulsion was thereby obtained with an average silver chloride grain size of 0.51 μm. The emulsion thereby obtained contained 504×10⁻⁹ mol Ir⁴⁺ and 0.625 nmol Rh³⁺ per mole of silver chloride.

The emulsion was then chemically ripened at a pH of 6.0 with 0.33×10⁻⁶ mol ammonium tetrachloroaurate and 1.10×10⁻⁶ mol sodium thiosulphate per mole of silver chloride for 240 minutes at a temperature of 45° C. After chemical ripening the following ingredients were added per mole AgCl at 40° C.: 0,6 mmol of the green sensitizing compound (GS-2), 2.4 mmol of the stabilizing compound EST-3, 1.2 mmol of the stabilizing compound (EST-1), 0,6 mmol of the stabilizing compound (XII-1) and finally 3 mmol of potassium bromide.

Red-Sensitive Emulsions EmR1-EmR3

EmR1

The precipitation, desalting and redispersion were carried out as described for EmG2. The emulsion was chemically ripened at a pH of 5.0 with 2.2×10⁻⁶ mol ammonium tetrachloroaurate and 9.0×10⁻⁶ mol sodium thiosulphate per mole silver chloride for 280 minutes at a temperature of 65° C. After chemical ripening the following ingredients were added per mole AgCl at 40° C.: 75 μmol of the spectral sensitizing compound (X-1), 2.5 mmol of the stabilizing compound EST-4 and finally 3 mmol of potassium bromide. The emulsion thereby obtained contained 5×10⁻⁹ mol Ir⁴⁺ and 2.5×10⁻⁹ mol Rh³⁺ per mole silver chloride.

EmR2

The precipitation, desalting and redispersion were carried out as described for EmR1, except that 142 μg K₂IrCl₆ and 3.8 Ag RhCl₃×3 H₂O were added to solution,22. The emulsion was chemically ripened at a pH of 5.0 with 1.32×10⁻⁶ mol ammonium tetrachloroaurate and 9.0×10⁻⁶ mol sodium thiosulphate per mole silver chloride for 280 minutes at a temperature of 65° C. After chemical ripening the following ingredients were added per mole AgCl at 40° C.: 75 mol of the spectral sensitizing compound (X-1), 2.5 mmol of the stabilizing compound EST-4 and finally 3 mmol of potassium bromide. The emulsion thereby obtained contained 50×10⁻⁹ mol Ir⁴⁺ and 2.5×10⁻⁹ mol Rh³ per mole silver chloride.

### EXAMPLE 1

A color photographic material, suitable for photographic processing, was prepared by coating the following layers in the following order onto a PVC plastic foil. The silver halide coverage is given as equivalent quantities of silver nitrate.

LAYER ASSEMBLY 111:

| | |
|---|---|
| Support: | 220 μm thick PVC toned white with TiO₂ |
| | (comprising no plastizisers) - |
| | corona pretreated |
| Subbing layer: | 0.4 g/m² gelatin |
| | 1.5 ml/m² 40% aqueous dispersion of |
| | dispersion D-1 |
| | 6.0 ml/m² 30% aqueous dispersion of |
| | colloidal silica |
| | (average particle size 0.025 μm, ph of 8) |
| | 0.1 ml/m² 5% aqueous solution of wetting agent |
| | Tergitol ® 4 (supplied by Niacet Corporation) |
| | 0.1 g/m² silane SL-1 |
| | 26.0 g/m² deionized water |
| Layer 2: | (blue-sensitive layer) |
| | Blue-sensitized silver halide emulsion EmB1 |
| | (99.94 mol-% chloride, 0.06 mol-% bromide, |
| | average grain size 0.85 μm) |
| | equivalent to 0.48 g/m² AgNO₃ |
| | 1.00 g/m² gelatin |
| | 0.20 g/m² yellow coupler GB-1 |
| | 0.40 g/m² yellow coupler GB-3 |
| | 0.30 g/m² tricresylphosphate (TKP) |
| | 0.10 g/m² stabilizer ST-1 |
| Layer 3: | (interlayer) |
| | 1.00 g/m² gelatin |
| | 0.06 g/m² Dox-scavenger SC-1 |
| | 0.06 g/m² Dox-scavenger SC-2 |
| | 0.12 g/m² TKP |
| Layer 4: | (green-sensitive layer) |
| | Green-sensitized silver halide emulsion EmG1 |
| | (99 mol-% chloride, 1 mol-% bromide, |
| | average grain size 0.37 μm) |
| | equivalent to 0.35 g/m² AgNO₃. |
| | 0.76 g/m² gelatin |
| | 0.44 g/m² magenta coupler XIV-43 |
| | 0.07 g/m² stabilizer ST-2 |
| | 0.14 g/m² stabilizer SC-2 |
| | 0.18 g/m² TKP |
| Layer 5: | (UV-protection layer) |
| | 1.05 g/m² gelatin |
| | 0.35 g/m² UV-Absorber UV-1 |
| | 0.20 g/m² UV-Absorber UV-2 |
| | 0.13 g/m² UV-Absorber UV-3 |
| | 0.06 g/m² Dox-scavenger SC-1 |
| | 0.06 g/m² Dox-scavenger SC-2 |
| | 0.33 g/m² TKP |
| Layer 6: | (red-sensitive layer) |
| | Red-sensitized silver halide emulsion EmR1 |
| | (99.0 mol-% chloride, 1 mol-% bromide, |
| | average grain size 0.37 μm) |
| | equivalent to 0.33 g/m² AgNO₃ |
| | 0.81 g/m² gelatin |
| | 0.42 g/m² cyan coupler VII-2 |
| | 0.20 g/m² TKP |
| | 0.20 g/m² dibutyl phthalate |
| Layer 7: | (UV-protection layer) |
| | 0.54 g/m² gelatin |
| | 0.35 g/m² UV-Absorber UV-1 |
| | 0.10 g/m² UV-Absorber UV-2 |
| | 0.05 g/m² UV-Absorber UV-3 |
| | 0.15 g/m² TKP |
| Layer 8: | (protective layer) |
| | 0.90 g/m² gelatin |
| | 0.05 g/m² brightener W-1 |
| | 0.07 g/m² polyvinylpyrrolidone |
| | 1.20 ml/m² silicon oil |
| | 2.50 mg/m² spacing agent of |
| | poly(methylmethacrylate), |
| | average particle size 0.8 μm |
| | 0.30 g/m² immediate hardening agent H-1 |

### EXAMPLES 2 to 9

The layer assemblies of the color photographic materials of EXAMPLES 2 to 9 with layer assemblies of 112, 113, 121 to 123 and 131 to 133 respectively were prepared analogously to that of EXAMPLE 1 except the differences that are summarized in Table 1:

TABLE 1

| Layer | | | | | |
|---|---|---|---|---|---|
| as- | | | | | |
| sem- | | Emulsion | | | |
| bly | Suport*⁾ | Layer 2 | Layer 4 | Layer 6 | Comment |
| 111 | A | EmB1 | EmG1 | EmR1 | Comparison EXAMPLE 1 |
| 112 | A | EmB2 | EmG2 | EmR2 | INVENTION EXAMPLE 2 |
| 113 | A | EmB3 | EmG3 | EmR2 | INVENTION EXAMPLE 3 |
| 121 | B | EmB1 | EmG1 | EmR1 | Comparison EXAMPLE 4 |
| 122 | B | EmB2 | EmG2 | EmR2 | INVENTION EXAMPLE 5 |
| 123 | B | EmB3 | EmG3 | EmR2 | INVENTION EXAMPLE 6 |
| 131 | C | EmB1 | EmG1 | EmR1 | Comparison EXAMPLE 7 |
| 132 | C | EmB2 | EmG2 | EmR2 | INVENTION EXAMPLE 8 |
| 133 | C | EmB3 | EmG3 | EmR2 | INVENTION EXAMPLE 9 |

*⁾Support A: 220 μm thick PVC toned white with TiO₂ (comprising no plastizisers) - corona pretreated
*⁾Support B: PC foil (175 μm thick; supplied by General Electric) - corona pretreated
*⁾Support C: 220 μm thick PVC toned white with TiO₂ (comprising plastizisers) - corona pretreated

Table 2 gives the quantity of iridium dopant and the preparation method used for the silver halide emulsion layers given in Table 1. The Ir-quantities are molar ratios with respect to silver halide.

TABLE 2

| | Emulsions | | | | | |
|---|---|---|---|---|---|---|
| | Layer 2 | | Layer 4 | | Layer 6 | |
| Layer | Ir- | Preparation | Ir- | Preparation | Ir- | Preparation |
| assembly | quantity | method | quantity | method | quantity | method |
| 111 | 5 | Double jet | 5 | Double jet | 5 | Double jet |
| 121 | | | | | | |
| 131 | | | | | | |
| 112 | 10 | Double jet | 100 | Double jet | 50 | Double jet |
| 122 | | | | | | |
| 132 | | | | | | |
| 113 | 10 | Mikrat | 504 | Mikrat | 50 | Mikrat |
| 123 | | recrystallization | | recrystallization | | recrystallization |
| 133 | | | | | | |

### Chemical Processing of Photographic materials of EXAMPLES 1 to 9

All the EXAMPLES were processed as follows:

a) developed for 45 s at 35° C. with a color developer with the following composition:

| | | |
|---|---|---|
| 9.0 | g | triethanolamine |
| 4.0 | g | N,N-diethylhydroxylamine |
| 0.05 | g | diethylenglycol |
| 5.0 | g | 3-methyl-4-amino-N-ethyl-N-methansulfonamidoethyl- |
| | | anilin-sulphate |
| 0.2 | g | potassium sulphite |
| 0.05 | g | triethylenglycol |
| 22 | g | potassium carbonate |
| 0.4 | g | potassium hydroxide |
| 2.2 | g | ethylendiamine-tetra-acetic acid disodium salt |
| 2.5 | g | potassium chloride |
| 0.3 | g | 1,2-dihydroxybenzol-3,4,6-trisulfonic acid |
| | | trisodium salt |

made up with water to 1000 mL; pH = 10.0

b) bleaching/fixing for 45 s at 35° C. with a bleacher/fixer bath with the following composition:

| | | |
|---|---|---|
| 75 | g | ammonium thiosulphate |
| 13.5 | g | sodium hydrogen sulphite |
| 2.0 | g | ammonium acetate |
| 57 | g | ethylene-diamine-tetra-acetic acid |
| | | iron ammonium salt |
| 9.5 | g | 25% aqueous ammonia |

made up with acetic acid to 1000 ml; pH = 5.5

c)washing with deionized water at 33° C. for 2 minutes

d)drying

### Evaluation of Sensitometric Properties of Color Photographic Materials of EXAMPLES 1 to 9

The sensitometric evaluation results obtained by digital laser exposure are presented in Table 3 in the form of the following parameters:

Dmin : Minimum density of the one day old material without exposure according to X-Rite Status A for the yellow layer (Dmin Y), the magenta layer (Dmin M) and the cyan layer (Dmin C).

Gamma-value G3: shoulder gradation ×100, i.e. 100 times the slope of the sensitometric curve between a density of Dₘᵢₙ +1.60 and a density of Dₘᵢₙ+2.15 of the one day old material according to X-Rite Status A for the yellow layer (G3 Y), the magenta layer (G3 M) and the cyan layer (G3 C).

One day old material means, that the unexposed and unprocessed material was stored for one day at a temperature of 25° C. without controlling the relative humidity. This is done to get better reproducible results.

Exposure

The sensitometric properties of the color photographic material were determined upon digital exposure by exposing it with an digital printer with the following technical specifications:

| | |
|---|---|
| Red laser: | wavelength of 683 nm |
| Green laser: | wavelength of 543 nm |
| Blue laser: | wavelength of 458 nm |
| Optical resolution: | 400 dpi |
| Exposure time: | approx. 131 ns per pixel |
| | (pixel exposure time) |
| Number of colour steps attained: | 256 per channel |

First an area of the sample was so exposed at an pixel exposure time of 131 ns with an intensity I, that the density D after processing was ca. 0.6 (according to X-Rite Status A). Then the light intensity was so reduced or increased that the logarithm of the exposure, log (I×t) was 0.1 lower or 0.1 higher than the previous exposure step. This procedure was followed until in total 29 steps were exposed. The lowest step corresponded to a zero light intensity (Dmin).

Storage Stability Test

A part of the freshly prepared unexposed and unprocessed material was stored for 4 weeks at 37° C. without controlling the relative humidity. Following the material was exposed, processed and sensitometrically evaluated as described above. Table 4 gives for example the difference of Dmin after storage minus Dmin of the one day old material as ADmin values and the difference of G3 after storage minus G3 of the one day old material as ΔG3 values.

Sensitometric Stability Results

The sensitometric results of the one day old layer assemblies are summarized in table 3.

TABLE 3

| Layer | Dmin | | | G3 | | |
|---|---|---|---|---|---|---|
| assembly | Y | M | C | Y | M | C |
| 111 | 0.135 | 0.137 | 0.124 | *) | 1.15 | 1.36 |
| 112 | 0.122 | 0.135 | 0.119 | 1.02 | 1.98 | 2.86 |
| 113 | 0.114 | 0.129 | 0.118 | 1.32 | 2.10 | 2.89 |
| 121 | 0.138 | 0.132 | 0.130 | *) | 1.18 | 1.43 |
| 122 | 0.130 | 0.128 | 0.125 | 1.15 | 2.03 | 2.78 |
| 123 | 0.124 | 0.124 | 0.120 | 1.28 | 2.11 | 2.90 |
| 131 | 0.143 | 0.143 | 0.141 | *) | 1.13 | 1.32 |
| 132 | 0.136 | 0.139 | 0.133 | 1.01 | 1.96 | 2.69 |
| 133 | 0.129 | 0.131 | 0.128 | 1.25 | 2.08 | 2.77 |

*) not measurable, because G3 was less then 0.100

The results given in table 3 clearly show, that the materials of the present invention, containing emulsions with a high iridium content exhibit a lower Dmin and a higher G3 then emulsions with less iridium and therefore are particularly suitable for digital exposure.

The sensitometric changes on storage of the layer assemblies are summarized in table 4.

TABLE 4

| Layer | ΔDmin | | | ΔG3 | | |
|---|---|---|---|---|---|---|
| assembly | Y | M | C | Y | M | C |
| 111 | 0.045 | 0.053 | 0.044 | **) | **) | **) |
| 112 | 0.037 | 0.048 | 0.029 | **) | −0.93 | −0.36 |
| 113 | 0.020 | 0.035 | 0.025 | −0.22 | −0.78 | −0.32 |
| 121 | 0.072 | 0.064 | 0.026 | **) | **) | −0.46 |
| 122 | 0.060 | 0.033 | 0.017 | **) | −0.95 | −0.29 |
| 123 | 0.035 | 0.020 | 0.015 | **) | −0.83 | −0.20 |
| 131 | 0.200 | 0.158 | 0.063 | **) | **) | **) |
| 132 | 0.083 | 0.087 | 0.041 | **) | −0.97 | −0.56 |
| 133 | 0.058 | 0.059 | 0.035 | **) | −0.93 | −0.36 |

**) not measurable, because G3 was less then 0.100 after storage

The results given in table 3 clearly show, that the materials of the present invention, containing emulsions with a high iridium content exhibit a better storage stability, that is especially pronounced for supports that contain additives like plastizisers.

### EXAMPLE 10

Layer assembly 200 consisted only of support A.

Image Quality and Deformation Test

Layer assemblies 111 to 113, 121 to 123 and 131 to 133 were digitally exposed as described above with an image comprising black characters of varying size (height 3 mm to 10 mm) and chemical processed as described for EXAMPLES 1 to 9.

On layer assembly 200 an image comprising black characters of varying size (height 3 mm to 10 mm) was produced by conventional offset printing.

A transparent PVC sheet of 80 μm precoated on one side with a polyethylene sheet 75 μm thick was laid onto the thus prepared image and laminated with the polyethylene in contact with the topcoat of the image layer of layer assemblies 111 to 113, 121 to 123, 131 to 133 and 200. A roller laminator was used for pressing together the superposed materials at a temperature of 104° C. measured within the sandwich.

After lamination the following deformation test was applied to layer assemblies 111 to 113, 121 to 123, 131 to 133 and 200. A membrane press was used to press the photographic material onto a work-piece that was pretreated with a wood glue and the test was run at a temperature of 95° C. The work-piece in the form of a drawer-front was made of chip-wood and had grooves in the form of half-pipes on its front, the half-pipes having a diameter of 0.8 cm. On deformation, the photographic material lying over the halfpipes is pressed in the halfpipe and thereby stretched. The material is also stretched at the front edges and corners of the work-piece. At the back-side of the work-piece, overhanging material is cut off. The test pieces were evaluated qualitatively with the following results:

Deformation Results

Layer assemblies 111 to 113, 131 to 133 and 200 could easily be deformed and exhibited neither cracks nor micro-cracks.

Layer assemblies 121 to 123 could be deformed, but needed longer then the layer assemblies mentioned before; they exhibited neither cracks nor micro-cracks.

Image Quality Results

The image quality was evaluated with the naked eye by looking at the black characters in the deformed part of the test pieces. Layer assemblies 111 to 113 and 131 to 133showed no loss in image quality at the deformed parts.

Layer assemblies 121 to 123 showed minor losses in image quality that were barely visible as a small loss in density (dark grey instead of black) of the characters in the deformed parts. Layer assembly 200 showed a significant loss in image quality in form of a clearly visible brightening of the characters in the deformed parts. Along the edges and corners grey and even white lines appear within the characters.

From the test results it is evident, that PVC and PC are preferred supports for the photographic material of the present invention, PVC containing no plastizisers being particularly preferred. The advantage of PVC is it's ease of deformation and thereby enabling a very smooth deformation that does not at all adversely effect the image quality of the deformed image. The offset printed material

The present invention may include any feature or combination of features disclosed herein either implicitly or explicitly or any generalisation thereof irrespective of whether it relates to the presently claimed invention. In view of the foregoing description it will be evident to a person skilled in the art that various modifications may be made within the scope of the invention.

Having described in detail preferred embodiments of the current invention, it will now be apparent to those skilled in the art that numerous modifications can be made therein without departing from the scope of the invention as defined in the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A deformable color photographic silver halide material, said color photographic silver halide material comprising on a deformable plastic support at least one blue-sensitive silver halide emulsion layer containing at least one yellow coupler, at least one green-sensitive silver halide emulsion layer containing at least one magenta coupler and at least one red-sensitive silver halide emulsion layer containing at least one cyan coupler, wherein the silver halide emulsions have an overall silver chloride content of at least 95 mol % and at least one silver halide emulsion contains silver halide crystals that are doped with 10 to 700 nmol iridium.

2. Material according to claim 1, wherein at least one silver halide emulsion contains silver halide crystals that are doped with 10 to 500 nmol iridium.

3. Material according to claim 2, wherein the silver halide emulsions have an overall silver chloride content of at least 98 mol %.

4. Material according to claim 1, wherein the silver halide crystals of at least one silver halide emulsion contains structured crystals with at least two different zones, the outermost zone having a higher molar content of silver bromide than the rest of the crystal.

5. Material according to claim 1, wherein said support is provided with a subbing layer comprising 1.3 to 80% by weight of a proteinaceous colloid, 0 to 85% by weight of colloidal silica and 0 to 30% by weight of a siloxane, which can form a reaction product with said colloidal silica.

6. Material according to claim 5, wherein said subbing layer is provided on the same side of said support as the silver halide emulsion layers.

7. Material according to claim 1, wherein said green-sensitive silver halide emulsion layer and/or said red-sensitive silver halide emulsion layer contain a silver halide emulsion with silver halide crystals having an average grain size of at least 0.4 4 μm.

8. Material according to claim 1, wherein said silver halide emulsion layers contain one or more binders.

9. Material according to claim 8, wherein said binders in said silver halide emulsion layers are at least 80% by weight gelatin.

10. Material according to claim 1, wherein said color photographic material contains at least one light-sensitive layer containing a compound represented by formula (XII): 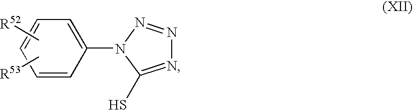
in which R⁵² represents H, CH₃ or OCH₃; R⁵³ represents H, OH, CH 3, OCH₃, NHCO—R⁵⁴, COOR⁵⁴, SO₂NH₂, NHCONH₂ or NHCONH—CH₃; and R⁵⁴ represents C₁-C₄-Alkyl.

11. Material according to claim 1, wherein said blue-sensitive silver halide emulsion layer contains a blue sensitizer represented by formula (IX): 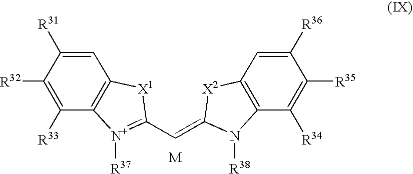
wherein X¹ and X² independently represent S or Se, R³¹ to R³⁶ independently represent hydrogen, halogen or an alkyl-, alkoxy, aryl or hetero-aryl group or R³¹ and R³²; R³² and R³³; R³⁴ and R³⁵; R³⁵ and R³⁶ together represent the atoms necessary to form an anellated benzo-, naphtho- or heterocyclic ring, R³⁷ and R³⁸ independently represent an alkyl-, sulfoalkyl-, carboxyalkyl, —(CH₂)₁SO₂R³⁹SO₂-alkyl, —(CH₂)₁SO₂R³⁹CO-alkyl, —(CH₂)₁COR³⁹SO₂-alkyl or —(CH₂) ₁—COR³⁹CO-alkyl group, R³⁹ represents —N¹³ — or —NH—, 1 is a whole number between 1 and 6 and M is an optional counter-ion providing charge compensation.

12. Material according to claim 1, wherein said deformable plastic support is a polycarbonate, poly(vinylchloride), vinylchloride copolymer or a polyester; or a copolyester based on PET.

13. Material according to claim 1, wherein the outermost layer on the image side of said color photographic material is provided with a protective foil.

14. A process for producing a deformed image comprising the steps of: exposing a deformable color photographic silver halide material, said color photographic silver halide material comprising on a deformable plastic support at least one blue-sensitive silver halide emulsion layer containing at least one yellow coupler, at least one green-sensitive silver halide emulsion layer containing at least one magenta coupler and at least one red-sensitive silver halide emulsion layer containing at least one cyan coupler, wherein the silver halide emulsions have an overall silver chloride content of at least 95 mol % and at least one silver halide emulsion contains silver halide crystals that are doped with 10 to 700 nmol iridium; conventionally processing said exposed color photographic material to produce an image; and deforming said color photographic material.

15. Process according to claim 14, wherein said deforming step comprises the application of heat and pressure and wherein at least part of the material is elongated.

16. Process according to claim 14, wherein said deforming step comprises deforming said deformable color photographic material in contact with a work piece.

17. Process according to claim 14, wherein said deformable color photographic silver halide material is provided with a protective foil before deforming said color photographic material with a work piece.

18. Process according to claim 14, wherein said deforming step comprises deforming said color photographic material by vacuum deformation.

19. Process according to claim 14, wherein said deforming step comprises deforming said color photographic material by injection moulding.
